(19) United States
(12) Patent Application Publication
(10) Pub. No.: US 2019/0090229 A1
(43) Pub. Date: Mar. 21, 2019

(54) RADIO ACCESS NETWORK NODE, EXTERNAL NODE, AND METHOD THEREFOR

(71) Applicant: NEC Corporation, Minato-ku, Tokyo (JP)

(72) Inventors: Takanori IWAI, Tokyo (JP); Ling XU, Tokyo (JP); Takaaki SUZUKI, Tokyo (JP); Yoshinori WATANABE, Tokyo (JP); Tomoaki HOKAO, Tokyo (JP); Tooru KIKUCHI, Tokyo (JP); Hideki BESSHO, Tokyo (JP)

(73) Assignee: NEC Corporation, Minato-ku, Tokyo (JP)

(21) Appl. No.: 16/086,345

(22) PCT Filed: Jan. 30, 2017
(86) PCT No.: PCT/JP2017/003124

§ 371 Date: Sep. 19, 2018

(30) Foreign Application Priority Data
Mar. 31, 2016 (JP) 2016-072422

(51) Int. Cl. H04W 72/04; H04W 72/12; H04L 12/927

(52) U.S. Cl. CPC H04W 72/048; H04W 72/1289; H04L 47/805; H04W 72/1247; H04L 47/803; H04W 72/1231

(57) ABSTRACT

An external node (5) receives a transmission history (1301) regarding a first communication event of a first radio terminal (1) from a node (2) located in a radio access network (3). The external node (5) transmits to the node (2) a control request (1302) to control at least one of: a communication module (521) disposed in the node (2) for communicating with the external node (5); a scheduler (503, 903) disposed in the node (2); a data buffer (502, 11) disposed in the node (2) or the first radio terminal (1); and the first radio terminal (1). It is thus, for example, possible to contribute to an improvement for adapting packet scheduling to communication performed by an application of a radio terminal.

### TECHNICAL FIELD

The present disclosure relates to a mobile communication network and, in particular, to packet scheduling in a radio access network.

### BACKGROUND ART

The European Telecommunications Standards Institute (ETSI) has started standardization of Mobile Edge Computing (MEC) (see Non-patent literatures 1 and 2). The MEC offers, to application developers and content providers, cloud-computing capabilities and an information technology (IT) service environment in the Radio Access Network (RAN) in close proximity to mobile subscribers. This environment provides ultra-low latency and high bandwidth as well as direct access to radio network information (subscriber's location, cell load etc.) that can be leveraged by applications and services.

The MEC server is integrally arranged with a RAN node. Specifically, the MEC server can be deployed at any one of the following sites: at a Long Term Evolution (LTE) base station (eNodeB) site, a 3G Radio Network Controller (RNC) site, and at a cell aggregation site. The cell aggregation site can be located indoors within an enterprise (e.g., a hospital, a large corporate headquarters), or indoors/outdoors in a public building or arena (e.g., a shopping mall, a stadium) to control a large number of local access points.

The MEC server provides applications (MEC applications) with computing resources, storage capacity, connectivity, and access to user traffic and radio network information. More specifically, the MEC server provides a hosting environment for applications by providing Infrastructure as a Service (IaaS) facilities or Platform as a Service (PaaS) facilities.

The MEC is based on a virtualized platform, similar to Network Function Virtualization (NFV). While NFV focuses on network functions, MEC enables applications to be run at the edge of the network. The infrastructure that hosts MEC is quite similar to the infrastructure that hosts NFV or network functions. Accordingly, it is beneficial to reuse the infrastructure and infrastructure management of NFV for MEC by hosting both Virtual Network Functions (VNFs) and MEC applications on the same platform.

### CITATION LIST

### Non Patent Literature

Non-patent Literature 1: Yun Chao Hu, Milan Patel, Dario Sabella, Nurit Sprecher, and Valerie Young, ETSI White Paper No. 11 “Mobile Edge Computing A key technology towards 5G” First edition, the European Telecommunications Standards Institute, September 2015
Non-patent Literature 2: ETSI GS MEC-IEG 004 V1.1.1 (2015-11) “Mobile-Edge Computing (MEC); Service Scenarios”, the European Telecommunications Standards Institute, November 2015

### SUMMARY OF INVENTION

### Technical Problem

The inventors have found several problems regarding the MEC, in particular, problems regarding packet scheduling (i.e., Medium Access Control (MAC) scheduling) performed by a RAN node (e.g., a radio base station (eNodeB/RNC)).

The role of the MAC scheduling is to attain objectives such as maximizing a cell capacity, maximizing fairness, or reducing power consumption while satisfying constraints including quality-of-service (QoS) requirements for bearers (or logical channels). An ordinary MAC scheduler considers channel quality and uses a capacity-maximizing algorithm or a proportional fair (PF) algorithm, or a combination thereof. Further, a scheduling algorithm applied to the MAC scheduler is contrived to satisfy QoS requirements such as a guaranteed bit rate (GBR) constraint and a delay constraint. Specifically, to satisfy the QoS requirements such as the GBR constraint and the delay constraint, an existing MAC scheduler considers a delay and a transmission deadline of each packet or segment (i.e., MAC Service Data Unit (SDU), or Radio Link Control Protocol (RLC) Protocol Data Unit (PDU)).

In some implementations, the MAC scheduler uses a scheduling metric (i.e., EDF metric) based on an Earliest Deadline First (EDF) approach. The EDF metric is in proportion to the reciprocal of the difference between the delay threshold and the head of line delay. The head of line delay means a delay of a first packet of the user's pending packets to be transmitted.

Additionally or alternatively, in some implementations, the MAC scheduler uses a PF metric weighted by a factor based on a transmission delay (e.g., a modified largest weighted delay first (LWDF) algorithm).

Additionally or alternatively, in some implementations, the MAC scheduler uses a scheduling metric that is in proportion to the number of pending packets to be transmitted (i.e., backlog or queue length) of a radio terminal.

Additionally or alternatively, in some implementations, the MAC scheduler includes a time-domain scheduler and a frequency-domain scheduler. The time-domain scheduler prioritizes a plurality of radio terminals and selects one or more radio terminals to be scheduled in each transmission period (e.g., each LTE subframe). The frequency-domain scheduler determines optimal mapping between radio resources (e.g., LTE resource blocks) in each transmission period and the radio terminal(s) selected by the time-domain scheduler. For example, the time-domain scheduler preferentially selects a radio terminal(s) whose bit rate is lower than its GBR or a radio terminal(s) whose EDF metric exceeds a reference value, to be scheduled in the current transmission period.

In regard to the packet scheduling (i.e., MAC scheduling) within a RAN, the inventors have studied the following situation: a MEC server requests a RAN node (e.g., eNodeB or RNC) to give special consideration to a specific radio terminal that uses MEC or is related to MEC. A specific MEC application hosted on a MEC server communicates with a specific application installed in a radio terminal connected to a RAN node. It might be possible to predict a communication characteristic of communication performed by such specific MEC application. The communication characteristic is, for example, the total size of data to be transmitted through a downlink (DL) or an uplink (UL) in a single communication event between the application layer of a radio terminal and the MEC application.

Considering a communication characteristic of the MEC application in the MAC scheduling in a RAN node may contribute to, for example, a more reliable guarantee of a delay requirement for a specific radio terminal that uses MEC or is related to MEC in the RAN. Alternatively, this consideration may contribute to relaxing the constraints on the scheduling and increasing radio resource utilization efficiency (or a system capacity or a system throughput).

Note that the aforementioned special consideration in the packet scheduling within the RAN is not limited to communication between the radio terminal and the MEC application, but may also be effective for communication performed by various applications of the radio terminal.

In view of the above, one of the objects to be attained by embodiments disclosed herein is to provide an apparatus, a method, and a program that contribute to an improvement for adapting packet scheduling to communication performed by an application of a radio terminal. It should be noted that the above-described object is merely one of the objects to be attained by the embodiments disclosed herein. Other objects or problems and novel features will be made apparent from the following description and the accompanying drawings.

### Solution to Problem

In a first aspect, a radio access network node includes a memory, and at least one processor coupled to the memory and configured to execute a plurality of modules. The plurality of modules includes a communication module and a scheduler. The communication module is configured to communicate with an external node. The scheduler is configured to schedule downlink transmission or uplink transmission of data segments from data buffers for respective radio terminals including a first radio terminal. The data buffer for the first radio terminal stores one or more data segments to be transmitted that are generated from each data packet arriving at the first radio terminal or at the radio access network node. The communication module is further configured to transmit to the external node a transmission history regarding a first communication event of the first radio terminal. The communication module is further configured to receive from the external node a control request to control at least one of the communication module, the scheduler, the data buffer, and the first radio terminal.

In a second aspect, a method performed in a radio access network node includes:

(a) transmitting to an external node a transmission history regarding a first communication event of a first radio terminal; and
(b) receiving from the external node a control request to control at least one of: a communication module disposed in the radio access network node for communicating with the external node; a scheduler disposed in the radio access network node; a data buffer disposed in the radio access network node or the first radio terminal; and the first radio terminal.

In a third aspect, an external node includes a memory, and at least one processor coupled to the memory and configured to execute a plurality of modules including a communication module configured to communicate with a radio access network node. The communication module is configured to receive a transmission history regarding a first communication event of a first radio terminal from the radio access network node and transmit to the radio access network node a control request to control at least one of: a module disposed in the radio access network node for communicating with the external node; a scheduler disposed in the radio access network node; a data buffer disposed in the radio access network node or the first radio terminal; and the first radio terminal.

In a fourth aspect, a method performed in an MEC server includes:

(a) receiving a transmission history regarding a first communication event of a first radio terminal from a radio access network node; and
(b) transmitting to the radio access network node a control request to control at least one of: a module disposed in the radio access network node for communicating with the external node; a scheduler disposed in the radio access network node; a data buffer disposed in the radio access network node or the first radio terminal; and the first radio terminal.

In a fifth aspect, a program includes a set of instructions (software codes) that, when loaded into a computer, causes the computer to perform a method according to the above-described second or fourth aspect.

### Advantageous Effects of Invention

According to the above-described aspects, it is possible to provide an apparatus, a method, and a program that contribute to an improvement for adapting packet scheduling to communication performed by an application of a radio terminal.

### BRIEF DESCRIPTION OF DRAWINGS

FIG. 1 shows a configuration example of a mobile communication network according to some embodiments;

FIG. 2 is a sequence diagram showing an example of operations performed by an eNodeB and an MEC server according to the first embodiment;

FIG. 3 is a flowchart showing an example of an operation performed by an MEC server according to the first embodiment;

FIG. 4 is a flowchart showing an example of an operation performed by an eNodeB according to the first embodiment;

FIG. 5 is a block diagram showing a configuration example regarding downlink scheduling of an eNodeB according to the first embodiment;

FIG. 6 is a flowchart showing an example of an operation performed by an eNodeB according to the first embodiment;

FIG. 7 is a flowchart showing an example of an operation performed by an eNodeB according to the first embodiment;

FIG. 8 is a flowchart showing an example of an operation performed by an eNodeB according to the first embodiment;

FIG. 9 is a block diagram showing a configuration example regarding uplink scheduling of an eNodeB according to the first embodiment;

FIG. 10 is a block diagram showing a configuration example of an MEC server according to the first embodiment;

FIG. 11 is a flowchart showing an example of an operation performed by an eNodeB according to a second embodiment;

FIG. 12 is a flowchart showing an example of an operation performed by an eNodeB according to the second embodiment;

FIG. 13 is a sequence diagram showing an example of operations performed by an eNodeB and an MEC server according to a third embodiment;

FIG. 14 shows a configuration example of an MEC server according to some embodiments; and

FIG. 15 shows a configuration example of an eNodeB according to some embodiments.

### DESCRIPTION OF EMBODIMENTS

Specific embodiments will be described hereinafter in detail with reference to the drawings. The same or corresponding elements are denoted by the same symbols throughout the drawings, and duplicated explanations are omitted as necessary for the sake of clarity.

The following embodiments will be described on the assumption that they are implemented for LTE or LTE-Advanced. However, these embodiments are not limited to LTE and LTE-Advanced and may also be applied to other mobile communication networks or systems such as 3rd Generation Partnership Project (3GPP) Universal Mobile Telecommunications System (UMTS), 3GPP2 CDMA2000 system, Global System for Mobile communications (GSM (Registered Trademark))/General packet radio service (GPRS) system, WiMAX system, and Mobile WiMAX system.

### First Embodiment

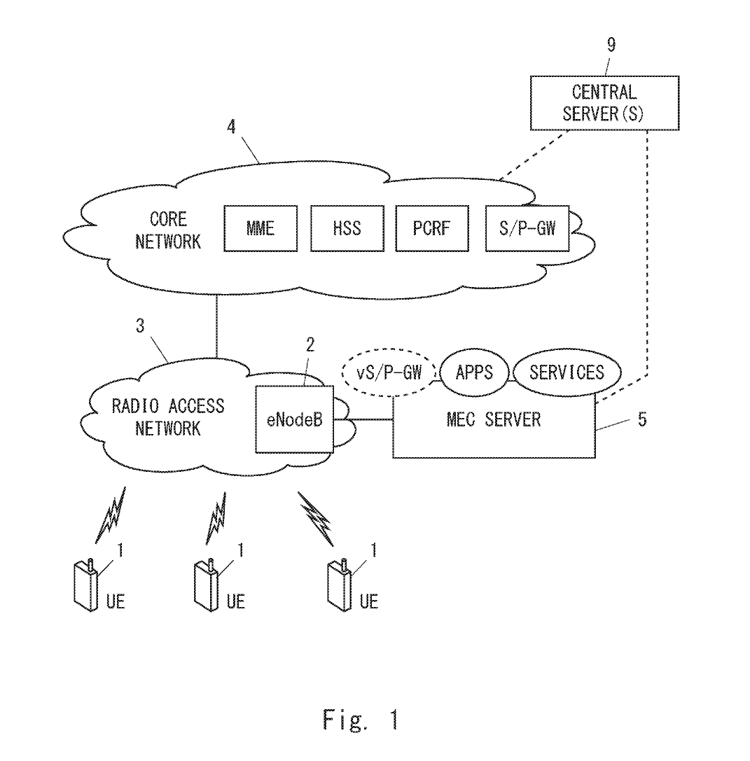

FIG. 1 shows a configuration example of a mobile communication network according to several embodiments including this embodiment. In the example shown in FIG. 1, the mobile communication network includes a RAN 3 (i.e., Evolved UMTS Terrestrial Radio Access Network (E-UTRAN)) and a core network 4 (i.e., Evolved Packet Core (EPC)). The RAN 3 includes an eNodeB 2. The eNodeB 2, which is arranged in the RAN 3, is configured to communicate with a plurality of radio terminals 1 (i.e., User Equipments (UEs)) connected to the RAN 3 and provide radio resource management for these UEs 1. For example, the radio resource management includes: establishment, modification, and release of a radio connection (e.g., Radio Resource Control (RRC) connection) with each UE 1; scheduling (i.e., radio resource allocation) of downlink transmission and uplink transmission of each UE 1; and controlling of a handover of each UE 1. The eNodeB 2 shown in FIG. 1 may be a macro cell base station or a femto cell base station.

The eNodeB 2 shown in FIG. 1 may be a Baseband Unit (BBU) used in the Centralized Radio Access Network (C-RAN) architecture. In other words, the eNodeB 2 shown in FIG. 1 may be a RAN node connected to one or more Remote Radio Heads (RRHs). In some implementations, the eNodeB 2 serving as the BBU is connected to the EPC 4, and is responsible for control-plane processing including radio resource management and for digital baseband signal processing for the user plane. Meanwhile, the RRU is responsible for analog Radio Frequency (RF) signal processing (e.g., frequency conversion and signal amplification). The C-RAN may also be referred to as a Cloud RAN. Further, the BBU may also be referred to as a Radio Equipment Controller (REC) or a Data Unit (DU). The RRH may also be referred to as a Radio Equipment (RE), a Radio Unit (RU), or a Remote Radio Unit (RRU).

Further, there is another C-RAN architecture in which a part of the baseband signal processing is arranged in the remote site. In some implementations, layer-1 (i.e., physical layer) baseband signal processing may be located in the remote site, and layer-2 (i.e., MAC sublayer, RLC sublayer, and Packet Data Convergence Protocol (PDCP) sublayer) and layer-3 signal processing may be located in the central site. In some implementations, the layer-1 signal processing and a part or all of the layer-2 signal processing may be located in the remote site, and the layer-3 signal processing may be located in the central site. The eNodeB 2 shown in FIG. 1 may be a data unit located in the central site in these C-RAN architectures.

The core network 4 is a network mainly managed by an operator that provides mobile communication services. The core network 4 includes a plurality of user plane entities (e.g., a Serving Gateway (S-GW) and a Packet Data Network Gateway (P-GW)) and a plurality of control plane entities (e.g., a Mobility Management Entity (MME), a Home Subscriber Server (HSS), and a Policy and Charging Rule Function (PCRF)). The user plane entities including an S/P-GW relay user data of the UEs 1 between the RAN 3 and an external network (i.e., Packet Data Network (PDN)). The control plane entities including an MME perform various kinds of control for the UEs 1, such as mobility management, session management (or bearer management), subscriber information management, and billing management.

A Mobile Edge Computing (MEC) server 5 is arranged in the RAN 3 in such a way that it can directly communicate with a radio access network (RAN) node (that is, without traversing the core network 4). The MEC server 5 may also be referred to as an edge server. In the example shown in FIG. 1, the MEC server 5 is arranged in the RAN 3 in such a way that it can directly communicate with the eNodeB 2. As described above, the eNodeB 2 may be a BBU. In some implementations, the MEC server 5 may be physically integrated with the eNodeB 2. In some implementations, the MEC server 5 may be installed in the same building (or site) as the eNodeB 2, and may be connected to the Local Area Network (LAN) in this site so that the MEC server 5 can communicate with the eNodeB 2.

The MEC server 5 is configured to provide at least one of computing resources and storage resources (or storage capacities) for edge computing related to a service or application directed to one or more UEs 1. In some implementations, the MEC server 5 may provide a hosting environment for MEC applications by providing IaaS or PaaS facilities.

The MEC server 5 may further include one or more of the functions of the core network 4. For example, the MEC server 5 may have the S-GW or S/P-GW function and terminate a bearer (e.g., Evolved Packet System (EPS) bearer) of the UE 1 that uses the MEC. As described above, the MEC architecture is similar to the NFV architecture. Accordingly, the MEC server 5 may host network functions including a virtualized S/P-GW (vS/P-GW) as well as the MEC applications.

In some implementations, the MEC server 5 may communicate with one or more central servers 9. The MEC server 5 may communicate with the central server 9 through the core network 4 or may communicate with the central server(s) 9 through the core network 4 or through a communication line (or a network) that does not traverse the core network 4. Further, although it is not shown in FIG. 1, the MEC server 5 may be connected to a plurality of eNodeBs 2.

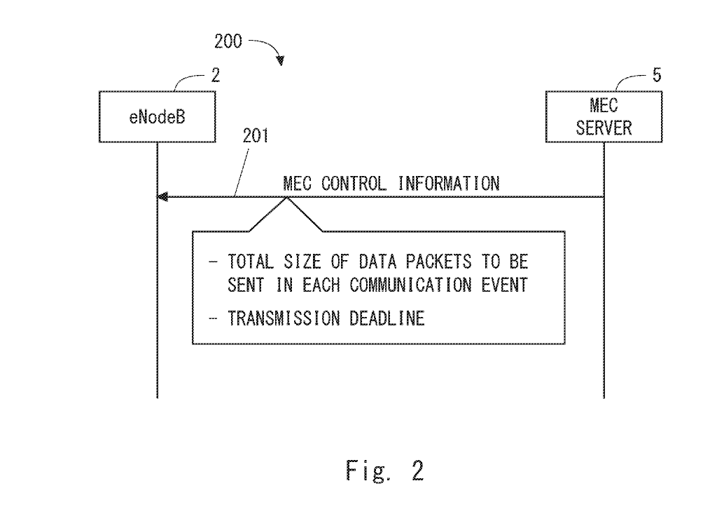

In the following, operations and configurations of the eNodeB 2 and the MEC server 5 for adapting packet scheduling (MAC scheduling) performed by the eNodeB 2 for communication performed by the MEC application are described. FIG. 2 is a sequence diagram showing a process 200 that is an example of operations performed by the eNodeB 2 and the MEC server 5. In Step 201, the MEC server 5 transmits MEC control information to the eNodeB 2. This MEC control information indicates a total size of a plurality of data packets to be transmitted in a communication event between an application layer of a specific UE 1 and an MEC application hosted in the MEC server 5, and a transmission deadline for these data packets. In some implementations, the MEC control information may indicate an identifier of one UE, an identifier of a plurality of UEs (i.e., UE group), or an identifier of a UE type. These identifiers are used by the eNB 2 to identify one or more specific UEs 1 to which the total size and the transmission deadline are applied.

One communication event between an application of a UE 1 and an MEC application may also be referred to as a communication transaction or a communication flow. One communication event, one communication transaction, or one communication flow includes unidirectional (i.e., DL or UL) or bidirectional (i.e., DL and UL) data transmission regarding a specific service. One communication event may be transmission of data (e.g., image data or location data of Global Navigation Satellite Systems (GNSS)) handled in the application layer. Specifically, for example, one communication event may be transmission of one or more image data from the MEC application to the application of the UE 1. In this case, the communication event includes at least DL transmission of one or more image data from the MEC server 5 to the UE 1. Further, this communication event may include UL transmission of user data (e.g., a request message for image data and a response message based on reception of the image data) from the UE 1 to the MEC server 5.

The total size of the plurality of data packets may indicate the total size of data packets sent in unidirectional (i.e., DL or UL) transmission in one communication event. Alternatively, the total size of the plurality of data packets may indicate the total size of DL data packets of DL transmission and the total size of UL data packets of UL transmission in one communication event.

The transmission deadline for the plurality of data packets means a time limit by which transmission of the plurality of data packets regarding one communication event should be completed. The transmission deadline is requested by an application. The transmission deadline can also be referred to as a transmission time limit. Alternatively, the transmission deadline can be referred to as a maximum transmission delay allowed by an application. The transmission deadline can be defined in various manners. For example, the transmission deadline may indicate a time limit for the completion of transmission by a sender in the application layer (i.e., the application of the UE 1 or the MEC application). Alternatively, the transmission deadline may indicate a time limit for the completion of transmission by a sender in a wireless layer (i.e., the UE 1 or the eNB 2). Alternatively, the transmission deadline may indicate a time limit for the completion of reception by a receiver in the application layer (i.e., the application of the UE 1 or the MEC application). Alternatively, the transmission deadline may indicate a time limit for the completion of reception by a receiver in the wireless layer (i.e., the UE 1 or the eNB 2). Alternatively, more specifically speaking, the transmission deadline may indicate a time period from when a sender in the application layer starts transmission of the first data packet regarding one communication event to when a receiver in the application layer completes reception of the last data packet regarding the one communication event. Alternatively, the transmission deadline may indicate a time period from when a sender in the wireless layer starts transmission of the first data packet regarding one communication event to when a receiver in the wireless layer completes reception of the last data packet regarding the one communication event.

The total size and the transmission deadline for the plurality of data packets to be transmitted between the UE 1 and the MEC application in one communication event are used by the eNodeB 2 to adapt the operation of the eNodeB 2 to communication characteristics of the MEC application. In other words, the MEC control information indicating the total size and the transmission deadline allows the eNodeB 2 to adapt its operation to communication characteristics of the MEC application. Specifically, the eNodeB 2 acquires a DL transmission history of the eNodeB 2 related to the communication event or a UL transmission history of the UE 1 related thereto, and calculates a size of remaining pending data packets to be transmitted based on the acquired transmission history and the above-described total size.

The DL transmission history may be a transmission amount of DL data segments (e.g., DL RLC PDUs) generated from one or more DL data packets of the communication event. The eNodeB 2 may acquire the transmission amount of DL RLC PDUs by monitoring a state of a DL transmission data buffer for the UE 1 disposed in the eNodeB 2. The transmission amount of DL RLC PDUs may be acquired by a MAC scheduler (i.e., DL MAC scheduler) in the eNodeB 2. Similarly, the UL transmission history may be a transmission amount of UL data segments (e.g., UL RLC PDUs) generated from one or more UL data packets of the communication event. The eNodeB 2 may acquire the transmission amount of UL RLC PDUs of the UE 1 by measuring UL RLC PDUs received by the eNodeB 2 from the UE 1. Alternatively, the eNodeB 2 may determine the transmission amount of UL RLC PDUs of the UE 1 based on UL grants issued to the UE 1.

In some implementations, the eNodeB 2 may determine a probability (or a deadline completion probability) that the transmission of the plurality of data packets to be transmitted in the communication event between the UE 1 and the MEC application will be completed by the transmission deadline. Specifically, the eNodeB 2 may determine the deadline completion probability based on the size of remaining pending data packets to be transmitted, the above-described transmission deadline, and a throughput of the UE 1. The throughput of the UE 1 may be, for example, a communication rate from the eNodeB 2 to the UE 1, a communication rate from the UE 1 to the eNodeB 2, or both, or a sum of both. Alternatively, the throughput of the UE 1 may be a communication rate from the MEC server 5 to the UE 1, a communication rate from the UE 1 to the MEC server 5, or both, or a sum of both. The eNodeB 2 may use a past average throughput of the UE 1 to determine the deadline completion probability, or may use a predicted current or future throughput to determine the deadline completion probability.

More specifically, in some implementations, with regard to the communication event, the eNodeB 2 may calculate a time until the completion of the transmission based on the size of remaining pending data packets to be transmitted in the UE 1 and the throughput of the communication rate from the UE 1 to the eNodeB 2 (or the throughput of the communication rate from the UE 1 to the MEC server 5), and determine the deadline completion probability based on the calculated time until the completion of the transmission and the transmission deadline. In another implementation, with regard to the communication event, the eNodeB 2 may calculate a time until the completion of the transmission based on the size of remaining pending data packets to be transmitted in the MEC server 5 or the eNodeB 2 and the throughput of the communication rate from the eNodeB 2 to the UE 1 (or the throughput of the communication rate from the MEC server 5 to the UE 1), and determine the deadline completion probability based on the calculated time until the completion of the transmission and the transmission deadline.

In yet another implementation, the eNodeB 2 may calculate a first time until the completion of the transmission based on the size of remaining pending data packets to be transmitted in the UE 1 and the throughput of the communication rate from the UE 1 to the eNodeB 2 (or the throughput of the communication rate from the UE 1 to the MEC server 5). Further, the eNodeB 2 may calculate a second time until the completion of the transmission based on the size of remaining pending data packets to be transmitted in the MEC server 5 or the eNodeB 2 and the throughput of the communication rate from the eNodeB 2 to the UE 1 (or the throughput of the communication rate from the MEC server 5 to the UE 1). Then, the eNodeB 2 may derive a (overall) third time required to complete the transmission of both the pending data packets in the UE 1 and the pending data packets in the MEC server 5 or the eNodeB 2 from these first and second times, and determine the deadline completion probability based on the calculated third time and the transmission deadline. The third time may be derived by simply adding, subtracting, multiplying, or dividing the first and second times, or may be derived by adding, subtracting, multiplying, or dividing the first and second times with different weights assigned to the first and second times. Alternatively, the third time may be derived by an arithmetic operation using a mathematical function in which the first and second times are used as variables.

The deadline completion probability may be defined in a manner such that the more likely the time until the transmission completion (or a time obtained by adding up times until completion of a plurality of transmissions) is to reach the transmission deadline, the lower the deadline completion probability becomes (i.e., since the transmission deadline is more likely to be exceeded, the completion probability is lowered). In other words, the deadline completion probability may be defined in a manner such that the less likely the time until the transmission completion (or a time obtained by adding up times until completion of a plurality of transmissions) is to reach the transmission deadline, the higher the deadline completion probability becomes (i.e., since the transmission deadline is less likely to be exceeded, the completion probability is raised).

The eNodeB 2 may determine that the deadline completion probability is equal to or lower than a predetermined threshold (or equal to or higher than a threshold). Alternatively, the eNodeB 2 may determine that a history of the deadline completion probability indicates a tendency to decrease (or increase). The eNodeB 2 may determine a probability (i.e., a deadline violation probability) that the deadline will not be met, instead of determining the deadline completion probability.

For example, the eNodeB 2 may control the MAC scheduler to increase radio resources to be allocated to the specific UE 1 or decrease radio resources to be allocated to another UE 1, in response to a decrease in the deadline completion probability (i.e., an increase in the deadline violation probability). In this way, the eNodeB 2 can increase the possibility that the specific UE 1 can meet its deadline. Alternatively, the eNodeB 2 may control the MAC scheduler to decrease radio resources to be allocated to the specific UE 1 or increase radio resources to be allocated to another UE 1, in response to a decrease in the deadline completion probability (i.e., an increase in the deadline violation probability). In this way, the eNodeB 2 can increase the possibility that the other UE 1 can meet its deadline.

Specifically, the eNodeB 2 may compare the values of the deadline completion probabilities of UEs 1 and perform scheduling for allocating radio resources (i.e., resource blocks (RBs)) to these UEs 1. More specifically, for example, this scheduling may be performed so as to allocate a larger number of RBs to a UE 1 having a higher deadline completion probability. Conversely, this scheduling may be performed so as to allocate a smaller number of RBs to a UE 1 having a lower deadline completion probability. Alternatively, this scheduling may be performed so as to allocate a larger number of RBs to a UE 1 having an average deadline completion probability (or a median deadline completion probability). The cycle at which this scheduling is performed may be equal to or longer than the scheduling cycle (i.e., transmission period or transmission time interval (TTI)) of the MAC scheduler. For example, in the case of an LTE MAC scheduler that performs scheduling for every 1 millisecond subframe, the predetermined cycle may be 10 milliseconds (i.e., one frame), or may be other periods.

Alternatively, the eNodeB 2 may change a parameter(s) that is taken into consideration by the MAC scheduler. The parameter includes, for example, at least one of a UE priority level, a QoS parameter (e.g., a QoS Class Indicator (QCI), a GBR, or a Prioritized Bit Rate (PBR)), a delay threshold, and a data transmission volume. The data transmission volume indicates an amount of data to be transmitted in a predetermined period for the specific UE 1 or its specific logical channel (i.e., bearer). The predetermined period may be equal to or longer than the scheduling cycle (i.e., the transmission period or the transmission time interval (TTI)) of the MAC scheduler. For example, in the case of an LTE MAC scheduler that performs scheduling for every 1 millisecond subframe, the predetermined cycle may be 10 milliseconds (i.e., one frame). Alternatively, the eNodeB 2 may change a scheduling strategy algorithm applied to the MAC scheduler. The scheduling strategy can also be referred to as a scheduling policy. The change of the scheduling strategy includes changing a scheduling algorithm, changing a definition (or a calculation formula) of a scheduling metric used in the scheduling algorithm, changing constraints that are takin into consideration in the scheduling, or any combination thereof.

Conversely, for example, the eNodeB 2 may control the MAC scheduler to decrease radio resources to be allocated to the specific UE 1 or increase radio resources to be allocated to another UE 1, in response to an increase in the deadline completion probability (i.e., a decrease in the deadline violation probability). In this way, the eNodeB 2 can relax the constraints on the scheduling and hence contribute to increasing the radio resource utilization efficiency. Alternatively, the eNodeB 2 may control the MAC scheduler to increase radio resources to be allocated to the specific UE 1 or decrease radio resources to be allocated to another UE 1, in response to an increase in the deadline completion probability (i.e., a decrease in the deadline violation probability). In this way, the eNodeB 2 can complete communication of the specific UE 1 in a shorter time and, after the completion of the communication, can allocate radio resources only to other UEs 1, which increases the radio resource utilization efficiency.

For example, in response to a decrease in the deadline completion probability (i.e., an increase in the deadline violation probability), the eNodeB 2 may change at least one parameter that affects a Logical Channel Prioritization (LCP) procedure performed by a MAC layer of the specific UE 1 to increase radio resources allocated to a specific UL logical channel (i.e., bearer) of the specific UE 1. The at least one parameter includes a logical channel priority, a PBR, a Bucket Size Duration (BSD), or any combination thereof. In the generation of an UL MAC PDU (i.e., transport block), the UE 1 multiplexes a plurality of logical channels configured in the UE 1 into one MAC PDU. The size of one MAC PDU (i.e., one transport block) depends on the resources allocated to the UE 1 by a UL grant from the eNodeB 2. In the generation of an UL MAC PDU, the QoS (i.e., PBR) of each radio bearer configured in the UL has to be guaranteed. Therefore, the UE 1 generates the UL MAC PDU according to the LCP procedure. In the LCP procedure, a priority and a PBR of each logical channel are taken into consideration. The PBR is a bit rate provided to one logical channel before allocating any resources to a lower-priority logical channel. The LCP procedure includes the first round and the second round. In the first round, for every logical channel, resources corresponding to the PBR are allocated in descending order of their priorities. The upper limit for resources allocated to each logical channel in the first round is equal to a bucket size of that logical channel. The bucket size of each logical channel is a value obtained by multiplying the PBR by the BSD. Next, in the second round, when there are remaining available resources even after the resources corresponding to the PBRs are provided to all the logical channels, the remaining resources are allocated to data of the logical channels in descending order of their priorities until no data of these logical channels remains or resources to be allocated are all used up.

Similarly to the UL, the eNodeB 2 may change at least one parameter that affects multiplexing of DL logical channels for generating a transport block (i.e., MAC PDU) to increase radio resources allocated to a specific DL logical channel (i.e., bearer) of the specific UE 1. The at least one parameter includes a logical channel priority, a PBR, a BSD, or any combination thereof.

In response to a decrease in the deadline completion probability (i.e., an increase in the deadline violation probability) regarding a specific communication event between the specific UE 1 and the MEC application, the eNodeB 2 may increase the priority, PBR, or BSD of a specific data radio bearer (i.e., logical channel) regarding this specific communication event. Additionally or alternatively, the eNodeB 2 may decrease the priority, PBR, or BSD of another data radio bearer (i.e., logical channel). In this way, the eNodeB 2 can increase the possibility that the deadline regarding the specific communication event between the specific UE 1 and the MEC application will be met.

For example, in response to a decrease in the deadline completion probability (i.e., an increase in the deadline violation probability), the eNodeB 2 may discard DL data segments (i.e., DL RLC PDUs) regarding the communication event stored in a DL transmission data buffer in the eNodeB 2. In this way, the eNodeB 2 can prevent radio resources from being consumed for data transmission in a communication event for which there is no longer a possibility of meeting the transmission deadline.

For example, in response to a decrease in the deadline completion probability (i.e., an increase in the deadline violation probability), the eNodeB 2 may request the MEC server 5 to change a DL (or UL) transmission data rate of the communication event or change a DL (or UL) transmission data rate of a communication event regarding another UE 1. The request sent from the eNodeB 2 for changing the transmission data rate triggers the MEC server 5 to adjust the data rate of the DL transmission performed by the MEC application or the data rate of the UL transmission of the application of the UE 1. Specifically, in response to the request from the eNodeB 2, the MEC server 5 may instruct the MEC application to adjust the data rate of the DL transmission by the MEC application or the data rate of the UL transmission of the application of the UE 1. Additionally or alternatively, the eNodeB 2 may request the MEC server 5 to decrease the total size of the communication event or defer the transmission deadline. In this way, the eNodeB 2 can increase the possibility of meeting the deadline.

Note that the above-described deadline completion probability and the deadline violation probability are merely examples of parameters that the eNodeB 2 can use to determine a possibility, feasibility, or likelihood that the transmission deadline can be met. The eNodeB 2 may determine the likelihood or possibility that the transmission deadline can be met based on other parameters or other techniques, and may perform the above-described scheduling control, the transmission data buffer control, or the request to the MEC server 5 in response to a decrease or an increase in the likelihood or possibility of meeting the transmission deadline.

For example, the eNodeB 2 may calculate a difference between a time (i.e., the time necessary for transmission) required for transmitting remaining pending data packets to be transmitted and a remaining time until the above-described transmission deadline, based on the size of the remaining pending data packets, the transmission deadline, and the throughput of the UE 1. Then, the eNodeB 2 may use this difference as a trigger metric for controlling the scheduling, controlling the transmission data buffer, or controlling the request to the MEC server 5.

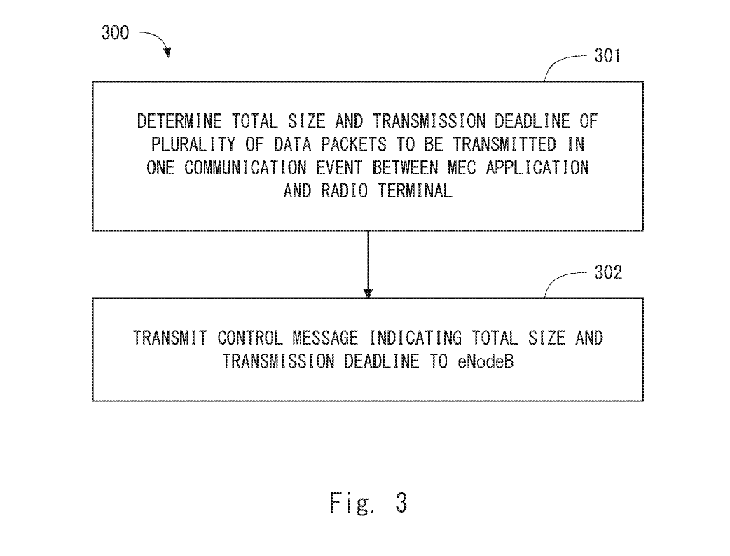

The following provides more details for specific examples of operations and configurations of the eNodeB 2 and the MEC server 5 according to this embodiment. FIG. 3 is a flowchart showing a process 300 that is an example of an operation performed by the MEC server 5.

In Step 301, the MEC server 5 determines a total size and a transmission deadline of a plurality of data packets to be transmitted in one communication event between the MEC application hosted in the MEC server 5 and the specific UE 1. The total size and the transmission deadline may be associated with an identifier (or a type) of the MEC application. That is, the MEC server 5 may use the identifier or the type of this MEC application to determine an MEC application that communicates with the specific UE 1, and then determine the total size and the transmission deadline of the plurality of data packets to be transmitted in one communication event.

Additionally or alternatively, the MEC server 5 may dynamically update the transmission deadline according to a status (e.g., a processing time) of an application. The processing time of a certain application could fluctuate. In some implementations, the processing time depends on, for example, Central Processing Unit (CPU) resources and memory resources of the MEC server 5 or the UE 1 allocated to the application. The processing time may depend on a processing load of a CPU regarding the application. Further, the processing time may depend on a time needed for the MEC server 5 or the UE 1 to communicate with another node (e.g., a database). Due to the fluctuations of the processing time of the application, a delay requirement (i.e., a transmission deadline) required for a mobile communication network to guarantee an end-to-end delay requirement also changes.

Additionally or alternatively, in response to a change in a state (or a context) of the UE 1, the eNodeB 2, or the RAN 3, the MEC server 5 may update either or both of the total size and the transmission deadline of the plurality of data packets to be transmitted in one communication event. For example, the MEC server 5 may receive information indicating a change in the state of the UE 1, the eNodeB 2, or the RAN 3 from the eNodeB 2.

In Step 302, the MEC server 5 transmits a control message indicating the determined total size and the determined transmission deadline to the eNodeB 2.

In some implementations, the MEC server 5 may perform the procedure shown in FIG. 3 in response to receiving a request or a notification from the eNodeB 2. Additionally or alternatively, the MEC server 5 may perform the procedure shown in FIG. 3 in response to receiving from the MEC application a request to communicate with the UE 1. Additionally or alternatively, the MEC server 5 may perform the procedure shown in FIG. 3 when it pages the UE 1 is response to a request from the MEC application.

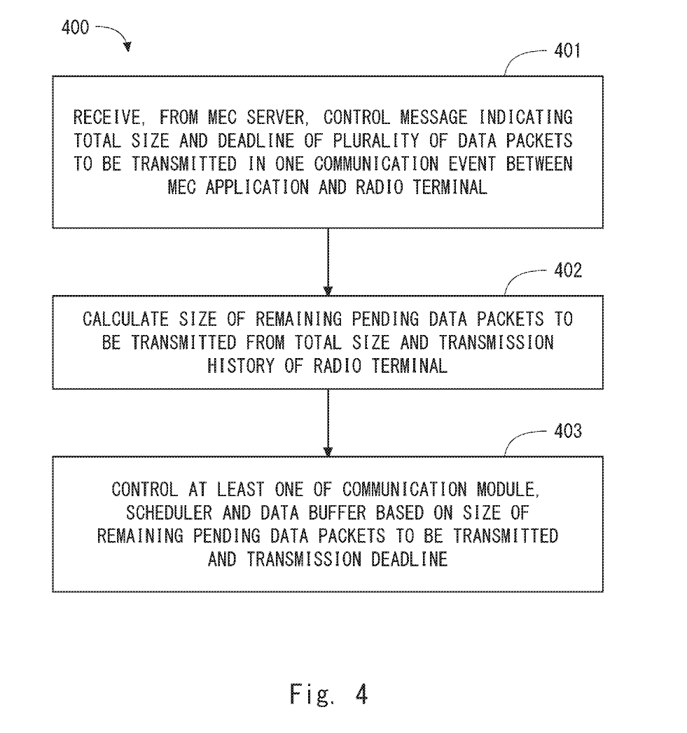

FIG. 4 is a flowchart showing a process 400 that is an example of an operation performed by the eNodeB 2. In Step 401, the eNodeB 2 receives from the MEC server 5 a control message indicating a total size and a deadline of a plurality of data packets to be transmitted in one communication event between the specific MEC application and the specific UE 1. In Step 402, the eNodeB 2 calculates the size of remaining pending data packets to be transmitted based on the total size and a transmission history of the specific UE 1. The eNodeB 2 repeatedly performs the process in Step 402 and updates the size of the remaining pending data packets to be transmitted. For example, the eNodeB 2 may calculate the size of remaining pending data packets to be transmitted at every scheduling cycle (i.e., every 1 millisecond) of the MAC scheduler.

In Step 403, the eNodeB 2 controls at least one of a communication module, a MAC scheduler, and a transmission data buffer based on the size of remaining pending data packets to be transmitted and the transmission deadline. As already described, the eNodeB 2 may calculate a deadline completion probability or a deadline violation probability. Then, in response to a decrease in the deadline completion probability (or an increase in the deadline violation probability), the eNodeB 2 may control at least one of the communication module (or an MEC interface), the MAC scheduler, the transmission data buffer, and the UE 1 (e.g., a LCP procedure by the UE 1). The communication module (or the MEC interface) provides an interface with the MEC server 5 and thereby enables the eNodeB 2 to transmit a control message to the MEC server 5. The MAC scheduler includes a DL MAC scheduler and a UL MAC scheduler. The transmission data buffer includes a DL transmission data buffer that is disposed in the eNodeB 2 and stores DL data segments (DL RLC PDUs), and a UL transmission data buffer that is disposed in the UE 1 and stores UL data segments (UL RLC PDUs).

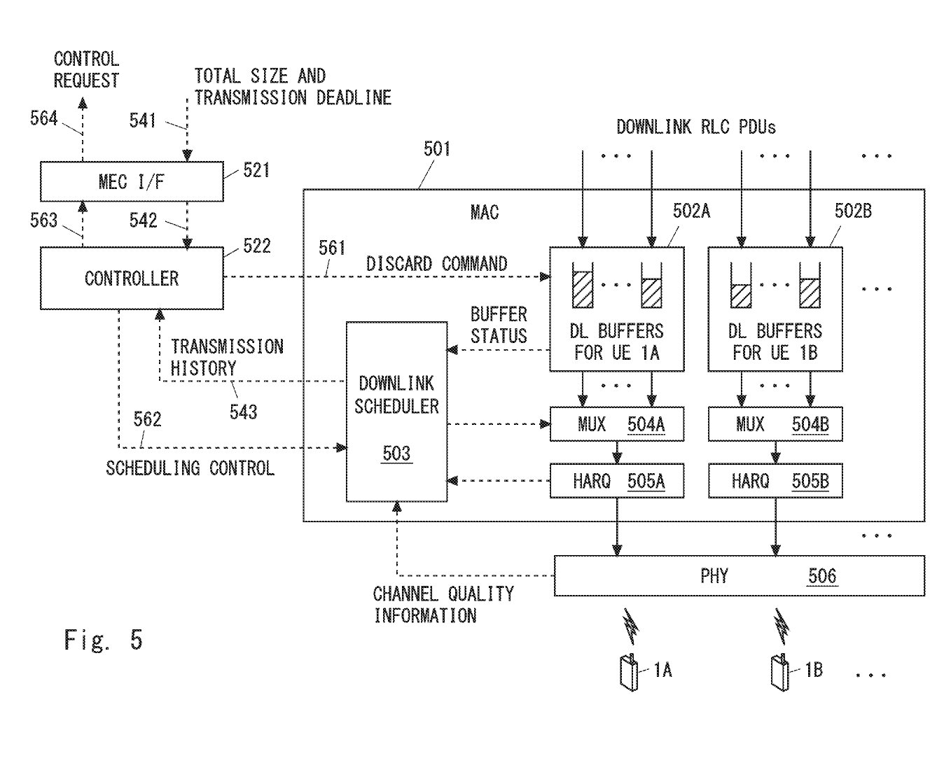

The following provides specific examples of the process performed in Step 403 of FIG. 4. Firstly, several examples of a process regarding DL data transmission will be described with reference to FIGS. 5 to 8. FIG. 5 is a block diagram showing a configuration example of the eNodeB 2 regarding DL transmission. A MAC sublayer 501 includes DL transmission data buffers 502, a DL scheduler 503, multiplexers 504, and Hybrid Automatic Repeat reQuest (HARQ) entities 505. The DL transmission data buffers 502 each store data segments (i.e., DL RLC PDUs) of one or more DL logical channels of a UE 1. The DL transmission data buffers 502 can also be referred to as DL transmission queues or RLC queues. The DL transmission data buffer 502A shown in FIG. 5 stores RLC PDUs of one or more DL logical channels of the UE 1A. The DL transmission data buffer 502B stores RLC PDUs of one or more DL logical channels of the UE 1B. The DL transmission data buffer 502 may be disposed in an RLC layer, instead of being disposed in the MAC layer 501.

The DL scheduler 503 schedules DL transmissions of a plurality of UEs 1 in the current transmission period (i.e., the current subframe) at least partly based on buffer states of the DL transmission buffers 502 and quality states of DL channels. The quality state of each DL channel is obtained from a Channel Quality Information (CQI) report from each UE 1. The DL scheduler 503 may take other information and other constraints into consideration for the DL scheduling. For example, the DL scheduler 503 may take account of a QoS requirement (e.g., a GBR) of each UE 1, a history of a transmission rate of each UE 1, a priority of each UE 1, or any combination thereof. In some implementations, the DL scheduler 503 includes a time-domain scheduler and a frequency-domain scheduler. The time-domain scheduler prioritizes a plurality of UEs 1 and selects one or more UEs 1 to be scheduled in each transmission period (i.e., each subframe). The frequency-domain scheduler determines optimal mapping between radio resources (i.e., resource blocks) in each transmission period and the UEs selected by the time-domain scheduler.

The multiplexers 504 each generate a transport block (i.e., a MAC PDU) to be transmitted in the current transmission period based on the allocation of radio resources to each UE 1 and a Modulation and Coding Scheme (MCS) determined by the DL scheduler 503. The multiplexer 504A shown in FIG. 5 generates a DL transport block to be transmitted to the UE 1A. The multiplexer 504B generates a DL transport block to be transmitted to the UE 1B.

Each HARQ entity 505 is in charge of a transmission HARQ operation. The transmission HARQ operation includes transmission and retransmission of a transport block, and reception and processing of ACK/NACK signaling. The HARQ entity 505A shown in FIG. 5 is in charge of a transmission HARQ operation for the UE 1A. The HARQ entity 505B is in charge of a transmission HARQ operation for the UE 1B.

A physical layer 506 encodes each transport block according to the MCS and the resource allocation determined by the DL scheduler 503, generates modulation symbols (i.e., Physical Downlink Shared Channel (PDSCH) symbols), and maps the modulation symbols into resource blocks.

An MEC interface (MEC I/F) 521 provides an interface with the MEC server 5 and enables the eNodeB 2 to transmit control messages to the MEC server 5 and receive control messages from the MEC server 5. The MEC interface 521 receives (541), from the MEC server 5, a total size and a transmission deadline of the plurality of DL data packets to be transmitted in one communication event between a specific UE 1 (e.g., the UE 1A) and a specific MEC application. The MEC interface 521 sends (542) the received total size and the received transmission deadline to a controller 522.

The controller 522 calculates the size of remaining pending data packets to be transmitted based on the total size of the plurality of DL data packets to be transmitted to the specific UE 1 (e.g., the UE 1A) (542) and a history of DL transmission to the specific UE 1 (543). The controller 522 controls at least one of the MEC interface 521, the DL scheduler 503, and the DL transmission data buffer 502 based on the calculated size of remaining pending data packets to be transmitted and the transmission deadline (542).

The controller 522 may receive the DL transmission history (543) from the DL scheduler 503. Alternatively, the controller 522 may monitor a change in a buffer state of the DL transmission data buffer 502 to acquire the DL transmission history (543).

In some implementations, the controller 522 may transmit a control command to the DL transmission data buffer 502 in response to a decrease in a deadline completion probability of the specific communication event (561). This control command triggers the DL transmission data buffer 502 (e.g., the buffer 502A) of the specific UE 1 (e.g., the UE 1A) to discard DL data segments (i.e., DL RLC PDUs) regarding the communication event stored in the DL transmission data buffer 502.

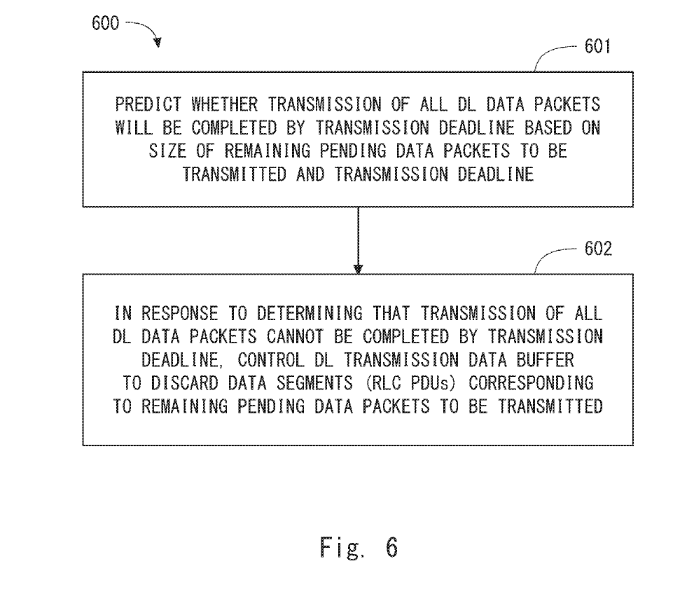

FIG. 6 is a flowchart showing a process 600 that is an example of an operation performed by the controller 522. In Step 601, the controller 522 predicts whether the transmission of all the DL data packets regarding a specific communication event will be completed by the transmission deadline based on the size of remaining pending data packets to be transmitted and the transmission deadline. In Step 602, in response to determining that the transmission of all the DL data packets cannot be completed by the transmission deadline, the controller 522 controls the DL transmission data buffer 502 to discard RLC PDUs corresponding to the remaining pending data packets to be transmitted.

In some implementations, the controller 522 may control scheduling performed by the DL scheduler 503 (562). For example, in response to a decrease in a deadline completion probability of the specific communication event, the controller 522 may control the DL scheduler 503 to increase radio resources to be allocated to the specific UE 1 (e.g., the UE 1A) or decrease radio resources to be allocated to other UEs 1 (e.g., the UE 1B). Conversely, in response to an increase in the deadline completion probability, the controller 522 may control the DL scheduler 503 to decrease radio resources to be allocated to the specific UE 1 (e.g., the UE 1A) or increase radio resources to be allocated to other UEs 1 (e.g., the UE 1B).

Alternatively, in response to a decrease in the deadline completion probability, the controller 522 may control the DL scheduler 503 to decrease radio resources to be allocated to the specific UE 1 (e.g., the UE 1A) or increase radio resources to be allocated to other UEs 1 (e.g., the UE 1B). Further, in response to an increase in the deadline completion probability, the controller 522 may control the DL scheduler 503 to increase radio resources to be allocated to the specific UE 1 (e.g., the UE 1A) or decrease radio resources to be allocated to other UE 1 (e.g., the UE 1B). Specifically, the controller 522 may change a parameter(s) that is taken into consideration by the DL scheduler 503. The parameter includes, for example, at least one of a UE priority level, a QoS parameter (e.g., a QCI, a GBR, or a PBR), a delay threshold, and a data transmission volume. Additionally or alternatively, the controller 522 may change a scheduling strategy used by the DL scheduler 503.

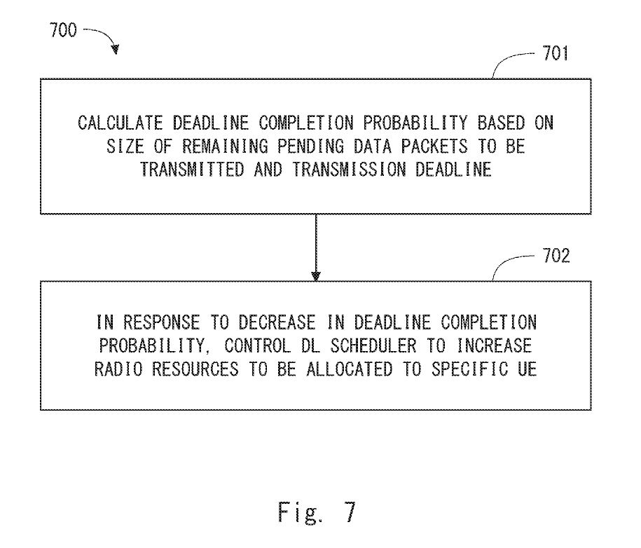

FIG. 7 is a flowchart showing a process 700 that is an example of an operation performed by the controller 522. In Step 701, the controller 522 calculates a deadline completion probability of the specific communication event based on the size of remaining pending data packets to be transmitted and the transmission deadline. The deadline completion probability is a probability that DL transmission of all the data packets regarding the specific communication event will be completed by the transmission deadline. In Step 702, in response to a decrease in the deadline completion probability, the controller 522 controls the DL scheduler 503 to increase radio resources to be allocated to the specific UE 1 participating in the specific communication event.

In some implementations, the controller 522 may transmit a control request to the MEC server 5 through the MEC interface 521 (563 and 564). For example, in response to a decrease in the deadline completion probability in the specific communication event, the controller 522 may request the MEC server 5 to change a DL transmission data rate of the specific communication event or a DL transmission data rate of another communications event. Specifically, the change in the data rate may be carried out through a control of an Internet Protocol (IP) queue (or buffer), a Transmission Control Protocol (TCP) queue (or buffer), or an application queue (or buffer) of the MEC server 5. The control of these queues (or buffers) may be priority control to give a higher priority to a specific packet in the queue (or buffer) in regard to the transmission order. Additionally or alternatively, the controller 522 may request the MEC server 5 to decrease the total size of the specific communication event or defer the transmission deadline.

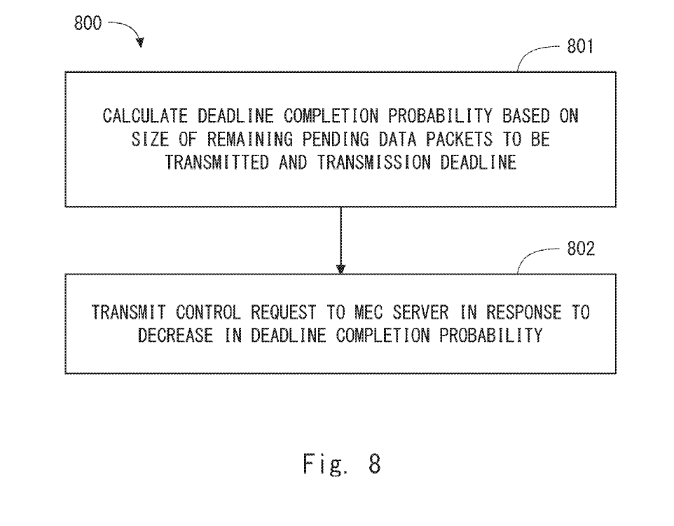

FIG. 8 is a flowchart showing a process 800 that is an example of an operation performed by the controller 522. In Step 801, the controller 522 calculates a deadline completion probability of the specific communication event based on the size of remaining pending data packets to be transmitted and the transmission deadline. In Step 802, the controller 522 transmits a control request to the MEC server 5 in response to a decrease in the deadline completion probability. For example, this control request requests the MEC server 5 to decrease a DL transmission rate of the specific communication event.

Further, the controller 522 may receive from the MEC server 5, through the MEC interface 521, a notification indicating a dynamic update of at least one of the total size and the transmission deadline of the plurality of DL data packets to be transmitted in one communication event. Upon receiving this notification, the controller 522 may control at least one of the MEC interface 521, the DL scheduler 503, and the DL transmission data buffer 502 based on the dynamically-updated total size or the dynamically-updated transmission deadline.

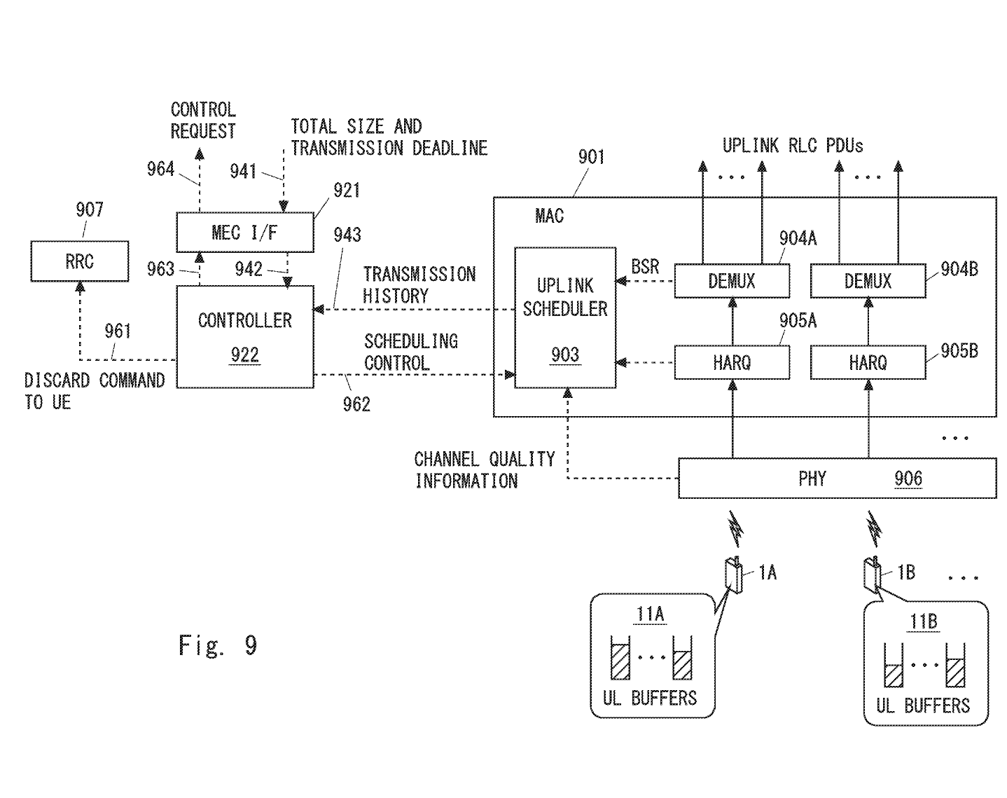

Next, specific examples of a process regarding UL data transmission performed in Step 403 of FIG. 4 will be described with reference to FIG. 9. FIG. 9 is a block diagram showing a configuration example of the eNodeB 2 regarding UL transmission. A UL scheduler 903 schedules UL transmission of a plurality of UEs 1 in the current transmission period (i.e., the current subframe) at least partly based on buffer states of UL transmission buffers 11 (e.g., a buffer 11A) in UEs 1 (e.g., the UE 1A) and quality states of UL channels. The quality state of each UL channel is acquired by a physical layer 906. The quality state of each UL channel indicates channel quality over a plurality of resource blocks between each UE 1 and the eNodeB 2. The buffer state of each UL transmission buffer 11 is obtained from a buffer Status Report (BSR) from each UE 1. Similarly to the above-described DL scheduler 503, the UL scheduler 903 may take other information and other constraints into consideration for the UL scheduling. In some implementations, the UL scheduler 903 includes a time-domain scheduler and a frequency-domain scheduler.

Demultiplexers 904 each obtain data segments (i.e., UL RLC PDUs) of one or more logical channels from received transport block (i.e., UL MAC PDU) and send them to an appropriate RLC entity. Further, the demultiplexers 904 each obtain a MAC control element (MAC CE) from the received transport block and send it to the UL scheduler 903. The MAC CE sent from the UE 1 includes a BSR. The demultiplexer 904A shown in FIG. 9 processes transport blocks received from the UE 1A. The demultiplexer 904B processes transport blocks from the UE 1B.

Each HARQ entity 905 is in charge of a reception HARQ operation. The reception HARQ operation includes reception of a transport block, synthesis of received data, and generation of ACK/NACK signaling. The HARQ entity 905A shown in FIG. 9 is in charge of a reception HARQ operation for the UE 1A. The HARQ entity 905B is in charge of a reception HARQ operation for the UE 1B.

An MEC interface (MEC I/F) 921 provides an interface with the MEC server 5 and enables the eNodeB 2 to transmit control messages to the MEC server 5 and receive control messages from the MEC server 5. The MEC interface 921 receives (941), from the MEC server 5, a total size and a transmission deadline of the plurality of UL data packets to be transmitted in one communication event between a specific UE 1 (e.g., the UE 1A) and a specific MEC application. The MEC interface 921 sends (942) the received total size and the received transmission deadline to a controller 922.

The controller 922 calculates the size of remaining pending data packets to be transmitted based on the total size of the plurality of UL data packets to be transmitted from the specific UE 1 (e.g., the UE 1A) (942) and a history of UL transmission from the specific UE 1 (943). The controller 922 controls at least one of the MEC interface 921, the UL scheduler 903, and the UL transmission data buffer 11 based on the calculated size of remaining pending data packets to be transmitted and the transmission deadline (942).

As already described, the UL transmission history (943) may be a transmission amount of UL data segments (e.g., UL RLC PDUs) generated from one or more UL data packets of the communication event. The controller 922 may receive the UL transmission history (943) from the UL scheduler 903. The UL scheduler 903 may acquire the transmission amount of UL RLC PDUs of the UE 1 by measuring UL RLC PDUs received from the UE 1. Alternatively, the UL scheduler 903 determines the transmission amount of UL RLC PDUs of the UE 1 based on UL grants issued to the UE 1.

In some implementations, the controller 922 may transmit a control command to the specific UE 1 (e.g., the UE 1A) in response to a decrease in a deadline completion probability of the specific communication event. For example, this control command may be transmitted to the specific UE 1 through an RRC entity 907 by using an RRC message (961). The control command triggers the specific UE 1 (e.g., the UE 1A) to discard UL data segments (i.e., UL RLC PDUs) that relate to the communication event and are stored in the UL transmission data buffer 11 (e.g., the buffer 11A) of the specific UE 1 (e.g., the UE 1A).

In some implementations, the controller 922 may control scheduling performed by the UL scheduler 903 (962). For example, in response to a decrease in a deadline completion probability of the specific communication event, the controller 922 may control the UL scheduler 903 to increase radio resources to be allocated to the specific UE 1 (e.g., the UE 1A) or decrease radio resources to be allocated to other UEs 1 (e.g., the UE 1B). Conversely, in response to an increase in the deadline completion probability, the controller 922 may control the UL scheduler 903 to decrease radio resources to be allocated to the specific UE 1 (e.g., the UE 1A) or increase radio resources to be allocated to other UEs 1 (e.g., the UE 1B).

Alternatively, in response to a decrease in the deadline completion probability, the controller 922 may control the UL scheduler 903 to decrease radio resources to be allocated to the specific UE 1 (e.g., the UE 1A) or increase radio resources to be allocated to other UEs 1 (e.g., the UE 1B). Further, in response to an increase in the deadline completion probability, the controller 922 may control the UL scheduler 903 to increase radio resources to be allocated to the specific UE 1 (e.g., the UE 1A) or decrease radio resources to be allocated to other UEs 1 (e.g., the UE 1B). Specifically, the controller 922 may change a parameter(s) that is taken into consideration by the UL scheduler 903. The parameter includes, for example, at least one of a UE priority level, a QoS parameter (e.g., a QCI, a GBR, or a PBR), a delay threshold, and a data transmission volume. Additionally or alternatively, the controller 922 may change a scheduling strategy used by the UL scheduler 903.

In some implementations, the controller 922 may transmit a control request to the MEC server 5 through the MEC interface 921 (963 and 964). For example, in response to a decrease in the deadline completion probability in the specific communication event, the controller 922 may request the MEC server 5 to change a UL transmission data rate of the specific communication event or a UL transmission data rate of another communications event. Specifically, the change in the data rate may be carried out through a control of an IP queue (or buffer), a TCP queue (or buffer), or an application queue (or buffer) of the MEC server 5. The control of these queues (or buffers) may be priority control to give a higher priority to a specific packet in the queue (or buffer) in regard to the transmission order. Additionally or alternatively, the controller 922 may request the MEC server 5 to decrease the total size of the specific communication event or defer the transmission deadline.

Further, the controller 922 may receive from the MEC server 5, through the MEC interface 921, a notification indicating a dynamic update of at least one of the total size and the transmission deadline of the plurality of UL data packets to be transmitted in one communication event. Upon receiving this notification, the controller 922 may control at least one of the MEC interface 921, the UL scheduler 903, and the UL transmission data buffer 11 based on the dynamically-updated total size or the dynamically-updated transmission deadline.

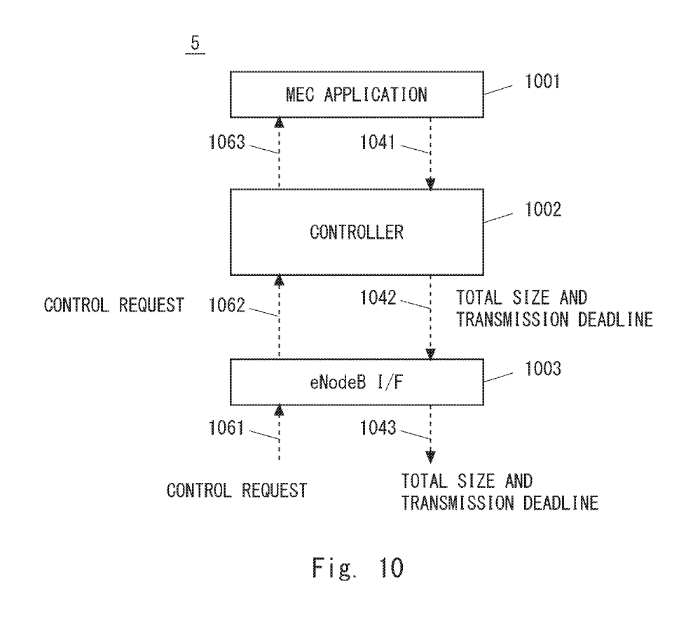

The following provides a configuration example of the MEC server with reference to FIG. 10. In the example shown in FIG. 10, the MEC server 5 includes an MEC application 1001, a controller 1002, and an eNodeB interface (eNodeB I/F) 1003. The MEC application 1001 is hosted on the MEC server 5. The controller 1002 determines a total size and a transmission deadline of the plurality of data packets to be transmitted in one communication event between the MEC application 1001 and the specific UE 1, and transmits the determined total size and transmission deadline to the eNodeB 2 through the eNodeB interface 1003 (1042 and 1043).

As already described, the total size and the transmission deadline of the plurality of data packets to be transmitted in one communication event may be associated with an identifier (or a type) of the MEC application 1001. The controller 1002 may use the identifier or the type of this MEC application 1001 to determine the MEC application 1001 that communicates with the specific UE 1, and then determine the total size and the transmission deadline of the plurality of data packets to be transmitted in one communication event. The controller 1002 may receive the total size and the transmission deadline of the plurality of data packets to be transmitted in one communication event from the MEC application 1001 (1041).

Further, the controller 1002 may receive a control request from the eNodeB 2 through the eNodeB interface 1003 (1061 and 1062). In an example, this control request requests an adjustment of a DL (or UL) transmission data rate. In another example, the control request requests a change in the total size or the transmission deadline of the plurality of data packets to be transmitted in one communication event. Upon receiving the control request from the eNodeB 2, the controller 1002 may request the MEC application 1001 to adjust the transmission data rate, the total size, or the transmission deadline (1063).

Further, the controller 1002 may determine a dynamic update of at least one of the total size and the transmission deadline of the plurality of data packets to be transmitted in one communication event and transmit a notification indicating the update(s) to the eNodeB 2 through the eNodeB interface 1003. For example, as already described, the controller 1002 may dynamically determine the transmission deadline according to a status (e.g., a processing time) of the application.

### Second Embodiment

This embodiment provides a modified example of the operation performed by the eNodeB 2 described in the first embodiment. A configuration example of a mobile communication network according to this embodiment is similar to that shown in FIG. 1.

In the first embodiment, examples in which the eNodeB 2 performs control regarding a DL based on the likelihood or possibility of meeting the deadline for transmission of DL data packets regarding an MEC application are described. The control regarding the DL is, for example, discarding of DL RLC PDUs, DL scheduling control, or transmission of a control request regarding the DL to the MEC server 5. Similarly, in the first embodiment, examples in which the eNodeB 2 performs control regarding a UL based on the deadline completion probability of transmission of UL data packets regarding an MEC application are described. The control regarding the UL is, for example, discarding of UL RLC PDUs, UL scheduling control, or transmission of a control request regarding the UL to the MEC server 5.

In contrast to this, in this embodiment, the eNodeB 2 performs control regarding a UL based on the likelihood or possibility of meeting the deadline for transmission of DL data packets regarding an MEC application. Further, the eNodeB 2 performs control regarding a DL based on the likelihood or possibility of meeting the deadline for transmission of UL data packets regarding the MEC application. Furthermore, the eNodeB 2 performs control regarding the DL and the UL based on both the likelihood or possibility of meeting the deadline for transmission of DL data packets regarding the MEC application and the likelihood or possibility of meeting the deadline for transmission of UL data packets regarding the MEC application (or based on a result obtained by combining both the likelihoods or possibilities). Some communication events between the application layer of the UE 1 and the MEC application may include bidirectional (i.e., DL and UL) data transmission. For example, in the case of request-response type communication, a delay in one direction (e.g., UL transmission) may cause a delay in the other direction (e.g., DL transmission). Alternatively, when data transmission in one direction (e.g., UL transmission) cannot meet the transmission deadline, the need to continue data transmission in the other direction (e.g., DL transmission) may be lost. According to this embodiment, it is possible to adapt packet scheduling performed by the eNodeB 2 to communication of a bidirectional-type MEC application.

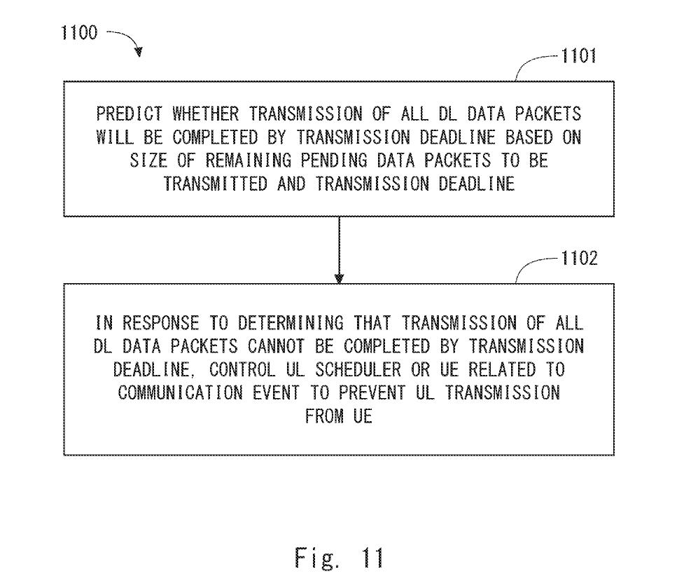

FIG. 11 is a flowchart showing a process 1100 that is an example of an operation performed by the eNodeB 2. In Step 1101, the eNodeB 2 (e.g., the controller 522 shown in FIG. 5 or the controller 922 shown in FIG. 9) predicts whether the transmission of all the DL data packets regarding a specific communication event will be completed by its transmission deadline, based on the size of remaining pending data packets to be transmitted and the transmission deadline. In Step 1102, in response to determining that the transmission of all the DL data packets cannot be completed by the transmission deadline, the eNodeB 2 controls the UL scheduler 903 or the UE 1 to stop UL transmission by this UE 1 regarding the communication event. For example, the eNodeB 2 may instruct the UE 1 to discard data segments stored in its UL transmission data buffer 11.

The roles in the UL and the DL shown in FIG. 11 may be interchanged. Specifically, in response to determining that the transmission of all the UL data packets cannot be completed by the transmission deadline, the eNodeB 2 controls the DL scheduler 503 or the DL transmission data buffer 502 to stop DL transmission to this UE 1 regarding the communication event. According to the above-described operations, it is possible to prevent radio resources in one direction (e.g., the UL) from being consumed for the communication event for which there is no longer a possibility of meeting the transmission deadline in the other direction (e.g., the DL).

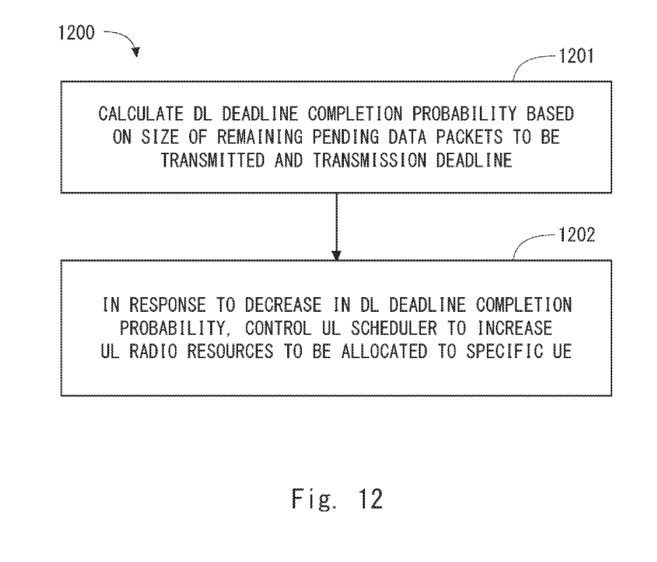

FIG. 12 is a flowchart showing a process 1200 that is another example of the operation performed by the eNodeB 2. In Step 1201, the eNodeB 2 (e.g., the controller 522 shown in FIG. 5 or the controller 922 shown in FIG. 9) calculates a DL deadline completion probability of a specific communication event based on the size of remaining pending data packets to be transmitted and the transmission deadline. The DL deadline completion probability is a probability that transmission of all the DL data packets regarding the specific communication event will be completed by the transmission deadline. In Step 1202, in response to a decrease in the DL deadline completion probability, the eNodeB 2 controls the UL scheduler 903 to increase radio resources to be allocated to the specific UE 1 participating in the specific communication event.

The roles in the UL and the DL shown in FIG. 12 may be interchanged. Specifically, in response to a decrease in the UL deadline completion probability, the eNodeB 2 controls the DL scheduler 503 to increase radio resources to be allocated to the specific UE 1 participating in the specific communication event. According to the above-described operations, it is possible to adjust scheduling in one direction (e.g., UL) to assist in meeting the transmission deadline in the other direction (e.g., DL). As a result, the eNodeB 2 can increase the possibility of meeting the deadline.

Further, the eNodeB 2 may control the UL scheduler 903 or the DL scheduler 503 based on a result obtained by combining the UL and DL deadline completion probabilities.

As already explained in the first embodiment, the deadline completion probability is a specific example of parameters that the eNodeB 2 can use to determine a possibility, feasibility, or likelihood that the transmission deadline can be met. The eNodeB 2 may determine the likelihood or possibility that the transmission deadline can be met based on other parameters or other techniques, and may control at least one of the communication module, the MAC scheduler, and the transmission data buffer in response to a decrease or an increase in the likelihood or possibility of meeting the transmission deadline.

### Third Embodiment

This embodiment provides a modified example of the operations performed by the eNodeB 2 and the MEC server 5 described in the first and second embodiments. A configuration example of a mobile communication network according to this embodiment is similar to that shown in FIG. 1.

The first and second embodiments provide examples in which the eNodeB 2 determines to carry out discarding of data segments, controlling of the scheduling, or sending of a control request to an MEC application on the basis of the size of pending data packets to be transmitted and the transmission deadline. For example, the eNodeB 2 predicts whether the transmission of all the data packets regarding a specific communication event will be completed by its transmission deadline, and in response to determining that the transmission deadline cannot be met, discards data segments regarding the specific communication event from a DL (or UL) transmission data buffer. Alternatively, the eNodeB 2 estimates deadline completion likelihood and, in response to a decrease or an increase in the deadline completion likelihood, adjusts scheduling performed by the DL (or UL) scheduler. For example, the eNodeB 2 calculates a deadline completion probability, and in response to determining that the deadline completion probability is lower than a predetermined threshold, controls the DL (or UL) scheduler to increase radio resources to be allocated to the specific UE 1 or decrease radio resources to be allocated to another UE 1

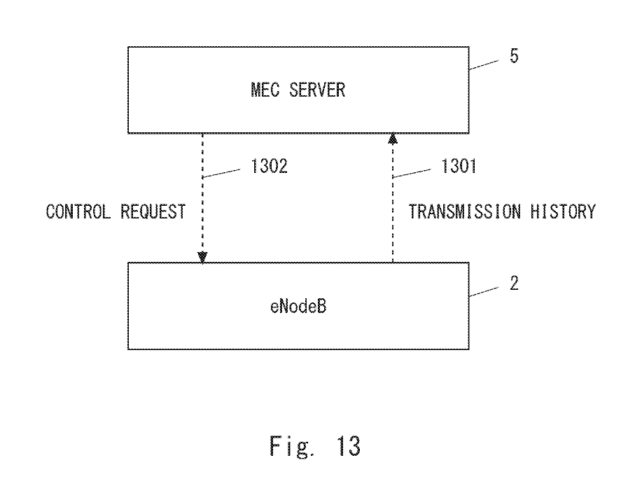

In this embodiment, meanwhile, the MEC server 5 performs these processes described in the first and second embodiments on behalf of the eNodeB 2. Operations performed by the eNodeB 2 and the MEC server 5 according to this embodiment are described with reference to FIG. 13. The eNodeB 2 transmits to the MEC server 5 a transmission history regarding a specific communication event regarding an MEC application (1301). This transmission history may be either or both of a DL transmission history and a UL transmission history. The DL transmission history may be a transmission amount of DL data segments (e.g., DL RLC PDUs) generated from one or more DL data packets of the specific communication event. The UL transmission history may be a transmission amount of UL data segments (e.g., UL RLC PDUs) generated from one or more UL data packets of the specific communication event.

The MEC server 5 transmits a control request to the eNodeB 2 (1302). In some implementations, this control request may be a data discarding request for a DL transmission data buffer in the eNodeB 2, or a UL transmission data buffer in the UE 1, or both. For example, in response to a decrease in deadline completion likelihood of the specific communication event calculated by the MEC server 5, the MEC server 5 may request the eNodeB 2 to discard data segments regarding the specific communication event from the DL transmission data buffer 502 in the eNodeB 2. According to the above-described operations, the eNodeB 2 and the MEC server 5 can prevent radio resources from being consumed for data transmission in the communication event for which there is no longer a possibility of meeting the transmission deadline.

Additionally or alternatively, the control request may be a scheduling adjusting request for the scheduler in the eNodeB 2 (e.g., either or both of the DL scheduler 503 and the UL scheduler 903). For example, in response to a decrease in the DL deadline completion likelihood of the specific communication event, the MEC server 5 may request the eNodeB 2 (the DL scheduler 503) to increase radio resources to be allocated to the specific UE 1 (e.g., the UE 1A) or decrease radio resources to be allocated to other UEs 1 (e.g., the UE 1B). Specifically, the control request may specify a parameter(s) that is taken into consideration by the scheduler. As already explained, the parameter that is taken into consideration by the scheduler includes, for example, at least one of a UE priority level, a QoS parameter (e.g., a QCI, a GBR, or a PBR), a delay threshold, and a data transmission volume. Additionally or alternatively, the control instruction may request a change of a scheduling strategy used by the scheduler. In this way, the eNodeB 2 and the MEC server 5 can increase the possibility of meeting the deadline.

Additionally or alternatively, the control request may request the eNodeB 2 to change an LCP procedure performed by the UE 1. For example, in response to a decrease in a DL deadline completion probability of the specific communication event, the MEC server 5 may request the eNodeB 2 (e.g., the controller 522 or 922) to increase radio resources to be allocated to a specific radio bearer (i.e., logical channel) regarding the specific communication event. Specifically, the control request may specify a parameter(s) that is taken into consideration in the LCP procedure. As already explained, the parameter that is taken into consideration in the LCP procedure includes at least one of a logical channel priority, a PBR, and a BSD. In this way, the eNodeB 2 and the MEC server 5 can increase the possibility of meeting the deadline.

Additionally or alternatively, the control request may be a control request to the communication module (e.g., the MEC interface 521 or 921) for communicating with the MEC server 5 in the eNodeB 2. For example, this control request may permit the eNodeB 2 to transmit a request to the MEC application. For example, the request to the MEC application may request to adjust a DL (or UL) transmission data rate of the MEC application or may request to change the total size or the transmission deadline of the plurality of data packets to be transmitted in one communication event between the MEC application and the specific UE 1.

More specifically, the MEC server 5 may operate as follows. The MEC server 5 acquires the total size or the transmission deadline of the plurality of data packets to be transmitted in one communication event between the MEC application and the specific UE 1. As described above, the MEC server 5 may use an identifier or a type of the MEC application to determine the total size and the transmission deadline of the plurality of data packets to be transmitted in one communication event. Alternatively, the MEC server 5 may receive the total size and the transmission deadline from the MEC application. Further, the MEC server 5 calculates the size of remaining pending data packets to be transmitted based on the total size and a transmission history received from the eNodeB 2. Furthermore, the MEC server 5 determines a deadline completion probability of the specific communication event based on the size of remaining pending data packets to be transmitted and the transmission deadline. The MEC server 5 may determine whether or not the deadline completion probability is equal to or lower than a predetermined threshold (or equal to or higher than a predetermined threshold). Alternatively, the MEC server 5 may determine whether a history of the deadline completion probability indicates a tendency to decrease (or increase). The MEC server 5 may determine a probability (i.e., a deadline violation probability) that the deadline will not be met, instead of determining the deadline completion probability. Note that specific examples of the definition of the deadline completion probability (or the deadline violation probability) and specific examples of the calculation of the deadline completion probability (or the deadline violation probability) according to this embodiment are similar to those described in the first embodiment, and repetitive descriptions are therefore omitted here.

According to this embodiment, similarly to the first and second embodiments, it is possible to adapt packet scheduling performed by the eNodeB 2 to communication performed by the MEC application.

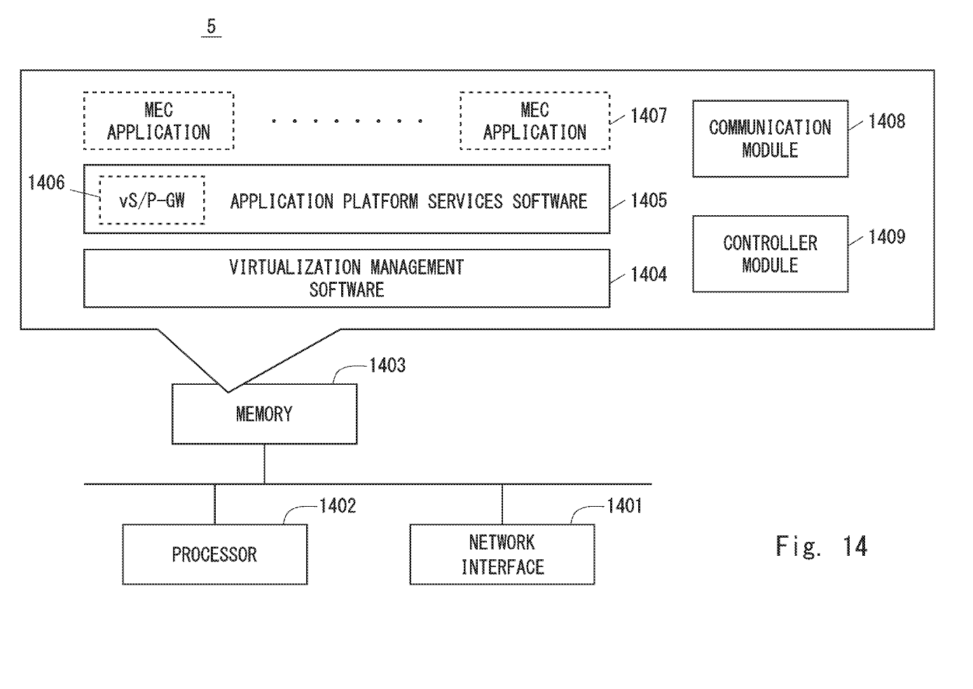

Lastly, configuration examples of the MEC server 5 and eNodeB 2 according to the above-described plurality of embodiments will be described. FIG. 14 is a block diagram showing a configuration example of the MEC server 5. As shown in FIG. 14, the MEC server 5 includes hardware components including a network interface 1401, a processor 1402, and a memory (or a storage) 1403. The network interface 1401 is used to communicate with the eNodeB 2 and other network nodes.

The network interface 1401 may include, for example, a network interface card (NIC) conforming to the IEEE 802.3 series.

The processor 1402 loads software (computer program) from the memory 1403 and executes the loaded software, thereby performing processing of the MEC server 5 described in the above embodiments with reference to the drawings. The processor 1402 may be, for example, a microprocessor, a Micro Processing Unit (MPU), or a Central Processing Unit (CPU). The processor 1402 may include a plurality of processors.

The memory 1403 is composed of a combination of a volatile memory and a nonvolatile memory. The memory 1403 may include a plurality of memory devices that are physically independent from one another. The volatile memory is, for example, a Static Random Access Memory (SRAM), a Dynamic RAM (DRAM) or a combination thereof. The nonvolatile memory is, for example, a mask Read Only Memory (MROM), an Electrically Erasable Programmable ROM (EEPROM), a flash memory, a hard disc drive, or any combination thereof. The memory 1403 may include a storage located apart from the processor 1402. In this case, the processor 1402 may access the memory 1403 via an I/O interface (not shown).

In the example shown in FIG. 14, the memory 1403 is used to store software modules 1404-1407 for MEC and a communication module 1408 for communicating with the eNodeB 2. The virtualization management software 1404 is executed by the processor 1402 to virtualize hardware components including the network interface 1401, the processor 1402, and the memory 1403 and provide Infrastructure as a Service (IaaS) or Platform as a Service (PaaS) facilities, thereby providing a hosting environment for applications.

The application platform services software 1405 is executed by the processor 1402 to provide applications with middleware services such as a communication service, a radio network information service, and a traffic offload function.

The application platform services software 1405 may include a virtualized S/P-GW software module 1406. The virtualized S/P-GW software module 1406 uses the hosting environment provided by the virtualization management software 1404, and provides functions of S-GW or P-GW or both.

The one or more applications 1407 are MEC applications hosted on the MEC server 5. The one or more applications 1407 communicate with the UE 1 using communication services provided by the application platform services software 1405 or the communication module 1408.

The communication module 1408 is executed by the processor 1402 and thereby provides the MEC application 1407 and the communication module 1408 with communication services for communicating with a RAN node (e.g., the eNodeB 2) according to the above-described embodiments. For example, the processor 1402 executes the communication module 1408, thereby functioning as the eNodeB interface 1003 shown in FIG. 10. In some implementations, the communication module 1408 may be included in the application platform services software 1405.

The controller module 1409 is executed by the processor 1402 and thereby provides control performed by the MEC server 5 according to the above-described embodiments. For example, the processor 1402 executes the controller module 1409, thereby functioning as the controller 1002 shown in FIG. 10.

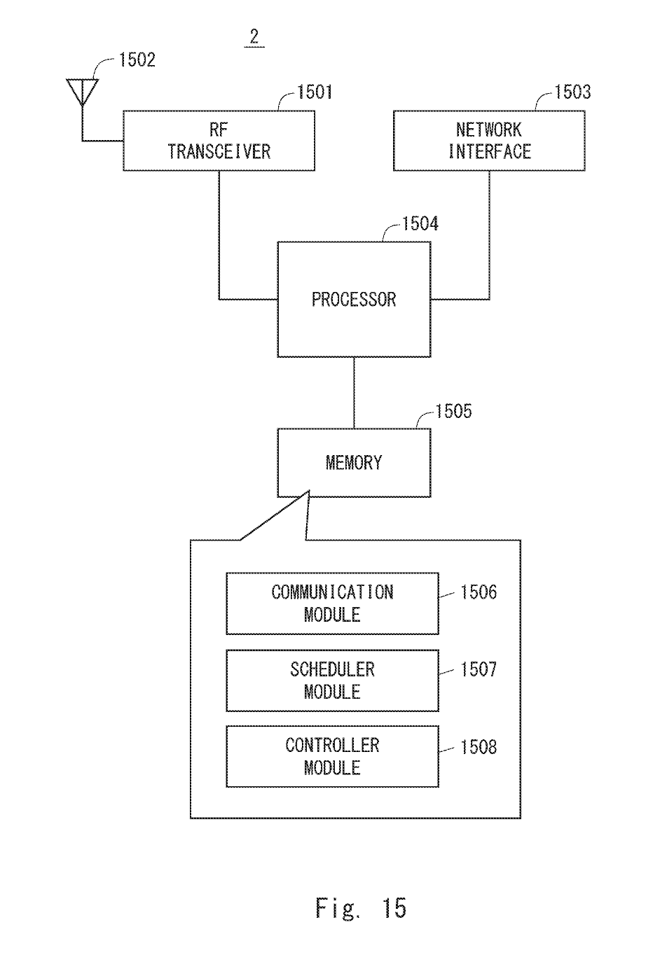

FIG. 15 is a block diagram showing a configuration example of the eNodeB 2 according to the above-described embodiments. As shown in FIG. 15, the eNodeB 2 includes an RF transceiver 1501, a network interface 1503, a processor 1504, and a memory 1505. The RF transceiver 1501 performs analog RF signal processing to communicate with the UE 1. The RF transceiver 1501 may include a plurality of transceivers. The RF transceiver 1501 is connected to an antenna 1502 and the processor 1504. In some implementations, the RF transceiver 1501 receives modulated symbol data (or OFDM symbol data) from the processor 1504, generates a transmission RF signal, and supplies the generated transmission RF signal to the antenna 1502. Further, the RF transceiver 1501 generates a baseband reception signal based on a reception RF signal received by the antenna 1502 and supplies this signal to the processor 1504. Note that as described above, the eNodeB 2 may be a BBU (or a REC) used in a C-RAN architecture. In this case, the eNodeB 2 may not include the RF transceiver 1501.

The network interface 1503 is used to communicate with a network node (e.g., a MME and an S/P-GW) and the MEC server 5.

The network interface 1503 may include, for example, a network interface card (NIC) conforming to the IEEE 802.3 series.

The processor 1504 performs digital baseband signal processing (i.e., data-plane processing) and control-plane processing for radio communication. For example, in the case of LTE or LTE-Advanced, the digital baseband signal processing performed by the processor 1504 may include signal processing of the PDCP layer, RLC layer, MAC layer, and PHY layer. Further, the control-plane processing performed by the processor 1504 may include processing of the S1 protocol, RRC protocol, and MAC CEs.

The processor 1504 may include a plurality of processors. The processor 1504 may include, for example, a modem-processor (e.g., DSP) that performs the digital baseband signal processing, and a protocol-stack-processor (e.g., CPU or MPU) that performs the control-plane processing.

The memory 1505 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disk drive, or a combination thereof. The memory 1505 may include a storage located apart from the processor 1504. In this case, the processor 1504 may access the memory 1505 through the network interface 1503 or an I/O interface (not shown).

The memory 1505 may store software modules (computer programs) including instructions and data to perform processing performed by the eNodeB 2 described in the above embodiments. In some implementations, the processor 1504 may be configured to load software modules from the memory 1505 and execute these loaded software modules, thereby performing the processing of the eNodeB 2 described in the above embodiments with reference to the drawings.

In the example shown in FIG. 15, the memory 1505 stores a communication module 1506, a scheduler module 1507, and a controller module 1508. The processor 1504 loads and executes the communication module 1506 to perform communication with the MEC server 5. The processor 1504 loads and executes the scheduler module 1507 to function as a DL scheduler and as a UL scheduler. The processor 1504 loads and executes the control module 1508 to provide various types of control based on a transmission deadline according to the above-described embodiments.

As described above with reference to FIGS. 14 and 15, each of the processors included in the MEC server 5 and the eNodeB 2 according to the above-described embodiment executes one or more programs including a set of instructions to cause a computer to perform an algorithm described above with reference to the drawings. These programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). These programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

### Other Embodiments

Each of the above embodiments may be used individually, or two or more of the embodiments may be appropriately combined with one another.

The above-described first and second embodiments provide examples in which the MEC server 5 notifies the eNodeB 2 of the total size and the transmission deadline of data packets to be transmitted in a communication event between the application layer of the UE 1 and the MEC application. Alternatively, in another embodiment, an external node different from the MEC server 5 may notify the eNodeB 2 of the total size and the transmission deadline. In yet another embodiment, an external node different from the MEC server 5 may receive the transmission history (1301) from the eNodeB 2 and transmit the control request (1302) to the eNodeB 2.

The communication event according to the first to third embodiments does not necessarily have to be communication between the application layer of the UE 1 and the MEC application. In other words, the communication event according to the above-described embodiments may be a communication event between an external server other than the MEC server 5 and the application layer of the UE 1. The external server may be, for example, an application server, an entity in a Machine-to-Machine (M2M) service platform, or an entity in a Cellular IoT (CIoT) service platform.

As already described, the above-described embodiments may be applied to a mobile communication network other than those in accordance with LTE or LTE-Advanced. For example, when the above-described embodiment is applied to 3GPP UMTS, the MEC server 5 may be arranged so as to directly communicate with an RNC that serves as an RAN node or a radio base station. In some implementations, the MEC server 5 may be physically integrated with an RNC. In some implementations, the MEC server 5 may disposed in the same building (or the same site) as an RNC and may be connected to a LAN in that site so that it can communicate with the RNC. The above-described embodiments may be applied to a communication network in accordance with evolution of the current LTE and LTE-Advanced (i.e., 3GPP LTE-Advanced Pro, LTE+, or enhanced LTE (eLTE)). In this case, the eNodeB 2 may be a base station in accordance with 3GPP LTE-Advanced Pro, LTE+, or enhanced LTE (eLTE). Further, the eNodeB 2 may be a base station that provides a new 5G air interface (i.e., new Radio Access Technology (RAT)) which is expected to be standardized as 3GPP Release 14.

The above-described embodiments are merely examples of applications of the technical ideas obtained by the inventors. These technical ideas are not limited to the above-described embodiments and various modifications can be made thereto.

For example, the whole or part of the embodiments disclosed above can be described as, but not limited to, the following supplementary notes.

### (Supplementary Note 1)

A radio access network node comprising:
a memory; and
at least one processor coupled to the memory and configured to execute a plurality of modules comprising:
   a communication module configured to communicate with an external node; and
   a scheduler configured to schedule downlink transmission or uplink transmission of data segments from data buffers for respective radio terminals including a first radio terminal, the data buffer for the first radio terminal storing one or more data segments to be transmitted that are generated from each data packet arriving at the first radio terminal or at the radio access network node, wherein
the communication module is configured to transmit to the external node a transmission history regarding a first communication event of the first radio terminal, and
the communication module is configured to receive from the external node a control request to control at least one of the communication module, the scheduler, the data buffer, and the first radio terminal.

### (Supplementary Note 2)

The radio access network node described in Supplementary note 1, wherein
the control request is transmitted in response to a decrease in likelihood of completing transmission of a plurality of data packets to be transmitted in the first communication event by a transmission deadline, and
the control request is configured to request the data buffer to discard a data segment generated from the plurality of data packets.

### (Supplementary Note 3)

The radio access network node described in Supplementary note 1 or 2, wherein
the control request is transmitted in response to a decrease or an increase in likelihood of completing transmission of a plurality of data packets to be transmitted in the first communication event by a transmission deadline, and
the control request is configured to request the scheduler to change a first parameter taken into consideration by the scheduler or change a scheduling strategy used by the scheduler.

### (Supplementary Note 4)

The radio access network node described in Supplementary note 3, wherein the first parameter includes at least one of a terminal priority level, a Quality of Service (QoS) parameter, a delay threshold, and a data transmission volume, which are related to the first radio terminal or another radio terminal.

### (Supplementary Note 5)

The radio access network node described in any one of Supplementary notes 1 to 4, wherein
the control request is transmitted in response to a decrease in likelihood of completing transmission of a plurality of data packets to be transmitted in the first communication event by a transmission deadline, and
the control request is configured to request the scheduler to increase radio resources to be allocated to the first radio terminal or decrease radio resources to be allocated to another radio terminal.

### (Supplementary Note 6)

The radio access network node described in any one of Supplementary notes 1 to 5, wherein the control request is configured to request a change of a second parameter used in a Logical Channel Prioritization (LCP) procedure in the first radio terminal to adjust radio resources to be allocated to a specific radio bearer or a specific logical channel regarding the first communication event.

### (Supplementary Note 7)

The radio access network node described in Supplementary note 6, wherein the second parameter includes at least one of a logical channel priority, a Prioritized Bit Rate (PBR), and a Bucket Size Duration (BSD).

### (Supplementary Note 8)

The radio access network node described in any one of Supplementary notes 1 to 7, wherein the external node is a mobile edge computing (MEC) server.

### (Supplementary Note 9)

The radio access network node described in Supplementary note 8, wherein the first communication event is a communication event between an application layer of the first radio terminal and an MEC application hosted in the MEC server.

### (Supplementary Note 10)

A method performed in a radio access network node, comprising:
transmitting to an external node a transmission history regarding a first communication event of a first radio terminal; and
receiving from the external node a control request to control at least one of: a communication module disposed in the radio access network node for communicating with the external node; a scheduler disposed in the radio access network node; a data buffer disposed in the radio access network node or the first radio terminal; and the first radio terminal.

### (Supplementary Note 11)

An external node comprising:
a memory; and
at least one processor coupled to the memory and configured to execute a plurality of modules comprising a communication module configured to communicate with a radio access network node, wherein
the communication module is configured to:
   receive a transmission history regarding a first communication event of a first radio terminal from the radio access network node; and
transmit to the radio access network node a control request to control at least one of: a module disposed in the radio access network node for communicating with the external node; a scheduler disposed in the radio access network node; a data buffer disposed in the radio access network node or the first radio terminal; and the first radio terminal.

### (Supplementary Note 12)

The external node described in Supplementary note 11, wherein
the communication module is configured to transmit the control request in response to a decrease in likelihood of completing transmission of a plurality of data packets to be transmitted in the first communication event by a transmission deadline, and
the control request is configured to request the data buffer to discard a data segment generated from the plurality of data packets.

### (Supplementary Note 13)

The external node described in Supplementary note 11 or 12, wherein
the communication module is configured to transmit the control request in response to a decrease or an increase in likelihood of completing transmission of a plurality of data packets to be transmitted in the first communication event by a transmission deadline, and
the control request is configured to request the scheduler to change a first parameter taken into consideration by the scheduler or change a scheduling strategy used by the scheduler.

### (Supplementary Note 14)

The external node described in Supplementary note 13, wherein the first parameter includes at least one of a terminal priority level, a Quality of Service (QoS) parameter, a delay threshold, and a data transmission volume, which are related to the first radio terminal or another radio terminal.

### (Supplementary Note 15)

The external node described in any one of Supplementary notes 11 to 14, wherein
the communication module is configured to transmit the control request in response to a decrease in likelihood of completing transmission of a plurality of data packets to be transmitted in the first communication event by a transmission deadline, and
the control request is configured to request the scheduler to increase radio resources to be allocated to the first radio terminal or decrease radio resources to be allocated to another radio terminal.

### (Supplementary Note 16)

The external node described in any one of Supplementary notes 11 to 15, wherein the control request is configured to request a change of a second parameter used in a Logical Channel Prioritization (LCP) procedure in the first radio terminal to adjust radio resources to be allocated to a specific radio bearer or a specific logical channel regarding the first communication event.

### (Supplementary Note 17)

The external node described in Supplementary note 16, wherein the second parameter includes at least one of a logical channel priority, a Prioritized Bit Rate (PBR), and a Bucket Size Duration (BSD).

### (Supplementary Note 18)

The external node described in any one of Supplementary notes 11 to 17, wherein the plurality of modules include a controller configured to determine whether to transmit the control request based on a size of remaining pending data packets to be transmitted that is derived from a total size of a plurality of data packets to be transmitted in the first communication event and a transmission history regarding the first radio terminal, and based on a transmission deadline of the plurality of data packets.

### (Supplementary Note 19)

The external node described in any one of Supplementary notes 11 to 18, wherein the first communication event is a communication event regarding an application layer of the first radio terminal.

### (Supplementary Note 20)

The external node described in any one of Supplementary notes 11 to 19, wherein the external node is a mobile edge computing (MEC) server.

### (Supplementary Note 21)

A method performed in an external node, comprising:
receiving a transmission history regarding a first communication event of a first radio terminal from a radio access network node; and
transmitting to the radio access network node a control request to control at least one of: a module disposed in the radio access network node for communicating with the external node; a scheduler disposed in the radio access network node; a data buffer disposed in the radio access network node or the first radio terminal; and the first radio terminal.

### (Supplementary Note 22)

A program for causing a computer to perform a method in a radio access network node, the method comprising:
transmitting to an external node a transmission history regarding a first communication event of a first radio terminal; and
receiving from the external node a control request to control at least one of: a communication module disposed in the radio access network node for communicating with the external node; a scheduler disposed in the radio access network node; a data buffer disposed in the radio access network node or the first radio terminal; and the first radio terminal.

### (Supplementary Note 23)

A program for causing a computer to perform a method in an external node, the method comprising:
receiving a transmission history regarding a first communication event of a first radio terminal from a radio access network node; and
transmitting to the radio access network node a control request to control at least one of: a module disposed in the radio access network node for communicating with the external node; a scheduler disposed in the radio access network node; a data buffer disposed in the radio access network node or the first radio terminal; and the first radio terminal.

This application is based upon and claims the benefit of priority from Japanese patent application No. 2016-072422, filed on Mar. 31, 2016, the disclosure of which is incorporated herein in its entirety by reference.

### REFERENCE SIGNS LIST

1 UE
2 eNodeB
3 RADIO ACCESS NETWORK
4 CORE NETWORK
5 MEC SERVER
503 DOWNLINK SCHEDULER
521 MEC INTERFACE
522 CONTROLLER
903 UPLINK SCHEDULER
921 MEC INTERFACE
922 CONTROLLER
1002 CONTROLLER
1003 eNodeB INTERFACE
1405 APPLICATION PLATFORM SERVICE SOFTWARE
1408 COMMUNICATION MODULE
1409 CONTROLLER MODULE
1506 COMMUNICATION MODULE
1507 SCHEDULER MODULE
1508 CONTROLLER MODULE

What is claimed is:

1. A radio access network node comprising:
a memory; and
at least one processor coupled to the memory and configured to execute a plurality of modules comprising:
a communication module configured to communicate with an external node; and
a scheduler configured to schedule downlink transmission or uplink transmission of data segments from data buffers for respective radio terminals including a first radio terminal, the data buffer for the first radio terminal storing one or more data segments to be transmitted that are generated from each data packet arriving at the first radio terminal or at the radio access network node, wherein
the communication module is configured to transmit to the external node a transmission history regarding a first communication event of the first radio terminal, and
the communication module is configured to receive from the external node a control request to control at least one of the communication module, the scheduler, the data buffer, and the first radio terminal.

2. The radio access network node according to claim 1, wherein
the control request is transmitted in response to a decrease in likelihood of completing transmission of a plurality of data packets to be transmitted in the first communication event by a transmission deadline, and
the control request is configured to request the data buffer to discard a data segment generated from the plurality of data packets.

3. The radio access network node according to claim 1, wherein
the control request is transmitted in response to a decrease or an increase in likelihood of completing transmission of a plurality of data packets to be transmitted in the first communication event by a transmission deadline, and
the control request is configured to request the scheduler to change a first parameter taken into consideration by the scheduler or change a scheduling strategy used by the scheduler.

4. The radio access network node according to claim 3, wherein the first parameter includes at least one of a terminal priority level, a Quality of Service (QoS) parameter, a delay threshold, and a data transmission volume, which are related to the first radio terminal or another radio terminal.

5. The radio access network node according to claim 1, wherein
the control request is transmitted in response to a decrease in likelihood of completing transmission of a plurality of data packets to be transmitted in the first communication event by a transmission deadline, and
the control request is configured to request the scheduler to increase radio resources to be allocated to the first radio terminal or decrease radio resources to be allocated to another radio terminal.

6. The radio access network node according to claim 1, wherein the control request is configured to request a change of a second parameter used in a Logical Channel Prioritization (LCP) procedure in the first radio terminal to adjust radio resources to be allocated to a specific radio bearer or a specific logical channel regarding the first communication event.

7. The radio access network node according to claim 6, wherein the second parameter includes at least one of a logical channel priority, a Prioritized Bit Rate (PBR), and a Bucket Size Duration (BSD).

8. The radio access network node according to claim 1, wherein the external node is a mobile edge computing (MEC) server.

9. The radio access network node according to claim 8, wherein the first communication event is a communication event between an application layer of the first radio terminal and an MEC application hosted in the MEC server.

10. A method performed in a radio access network node, comprising:
transmitting to an external node a transmission history regarding a first communication event of a first radio terminal; and
receiving from the external node a control request to control at least one of: a communication module disposed in the radio access network node for communicating with the external node; a scheduler disposed in the radio access network node; a data buffer disposed in the radio access network node or the first radio terminal; and the first radio terminal.

11. An external node comprising:
a memory; and
at least one processor coupled to the memory and configured to execute a plurality of modules comprising a communication module configured to communicate with a radio access network node, wherein
the communication module is configured to:
receive a transmission history regarding a first communication event of a first radio terminal from the radio access network node; and
transmit to the radio access network node a control request to control at least one of: a module disposed in the radio access network node for communicating with the external node; a scheduler disposed in the radio access network node; a data buffer disposed in the radio access network node or the first radio terminal; and the first radio terminal.

12. The external node according to claim 11, wherein
the communication module is configured to transmit the control request in response to a decrease in likelihood of completing transmission of a plurality of data packets to be transmitted in the first communication event by a transmission deadline, and
the control request is configured to request the data buffer to discard a data segment generated from the plurality of data packets.

13. The external node according to claim 11, wherein
the communication module is configured to transmit the control request in response to a decrease or an increase in likelihood of completing transmission of a plurality of data packets to be transmitted in the first communication event by a transmission deadline, and
the control request is configured to request the scheduler to change a first parameter taken into consideration by the scheduler or change a scheduling strategy used by the scheduler.

14. The external node according to claim 13, wherein the first parameter includes at least one of a terminal priority level, a Quality of Service (QoS) parameter, a delay threshold, and a data transmission volume, which are related to the first radio terminal or another radio terminal.

15. The external node according to claim 11, wherein
the communication module is configured to transmit the control request in response to a decrease in likelihood of completing transmission of a plurality of data packets to be transmitted in the first communication event by a transmission deadline, and
the control request is configured to request the scheduler to increase radio resources to be allocated to the first radio terminal or decrease radio resources to be allocated to another radio terminal.

16. The external node according to claim 11, wherein the control request is configured to request a change of a second parameter used in a Logical Channel Prioritization (LCP) procedure in the first radio terminal to adjust radio resources to be allocated to a specific radio bearer or a specific logical channel regarding the first communication event.

17. The external node according to claim 16, wherein the second parameter includes at least one of a logical channel priority, a Prioritized Bit Rate (PBR), and a Bucket Size Duration (BSD).

18. The external node according to claim 11, wherein the plurality of modules include a controller configured to determine whether to transmit the control request, based on a size of remaining pending data packets to be transmitted that is derived from a total size of a plurality of data packets to be transmitted in the first communication event and a transmission history regarding the first radio terminal, and based on a transmission deadline of the plurality of data packets.

19. The external node according to claim 11, wherein the first communication event is a communication event regarding an application layer of the first radio terminal.

20. The external node according to claim 11, wherein the external node is a mobile edge computing (MEC) server.

21. (canceled)

22. (canceled)

23. (canceled)
